(19) United States
(12) Patent Application Publication
(10) Pub. No.: US 2022/0210238 A1
(43) Pub. Date: Jun. 30, 2022

(54) NOTIFICATIONS AND SUBSCRIPTIONS FOR A DEVICE NEWS APPLICATION

(71) Applicant: Apple Inc., Cupertino, CA (US)

(72) Inventors: Shawn D. Moon, San Mateo, CA (US); Dana J. DuBois, San Francisco, CA (US); Guillermo Ortiz, Vancouver, WA (US); Manikandan Selvaraju, Santa Clara, CA (US)

(21) Appl. No.: 17/549,385

(22) Filed: Dec. 13, 2021

Related U.S. Application Data
(63) Continuation of application No. 15/453,890, filed on Mar. 8, 2017, now abandoned.
(60) Provisional application No. 62/349,038, filed on Jun. 12, 2016.

(51) Int. Cl. H04L 67/55; G06Q 20/40

(52) U.S. Cl. CPC H04L 67/26; G06Q 20/4014

(57) ABSTRACT

A method of providing subscription for a news channel by a news application of an electronic device is provided. The method displays a summary list of a set of articles from a news channel. The summary list includes an article that requires a subscription to the news channel in order to display the article. The method receives a selection to display the full article. The method determines that the device does not include a subscription to the news channel. The method displays a subscription offer by the news application. The subscription offer is optionally provided by a publisher of the news channel.

### CLAIM OF BENEFIT TO PRIOR APPLICATIONS

This application is a continuation of U.S. Non-Provisional patent application Ser. No. 15/453,890, filed Mar. 8, 2017, which claims the benefit of U.S. Provisional Patent Application No. 62/349,038, filed Jun. 12, 2016, which are herein incorporated by references in its entirety for all purposes.

### BACKGROUND

News applications often provide notifications for breaking news and important events. The notifications keep the readers abreast of the major events. When an electronic device such as a smartphone, a touchpad, a laptop, a computer, etc., has installed multiple news applications, different applications may use different criteria to display news notifications on a device.

Online news publishers provide a mixture of articles that are free to read and articles that require subscription. It is desirable to provide a news application for individual electronic devices to uniformly control notifications and subscriptions from different news publishers on the device.

### SUMMARY

Some embodiments provide a news client application for electronic devices such as smartphones, touchpads, laptops, computers, etc., that allows readers to customize the topics they are interested in, create a list of favorite news channels, explore different news topics, search for specific news items, and read news articles. The news application provides tools for a user to control the news channels that are allowed to provide news notifications. Notifications provide s for breaking news, big events, developing stories and so on.

The news application provides several different novel methods for controlling which channel is allowed to provide news notifications. A notification configuration page allows notification from individual news channels to be turned on or off. The news channels that provide notifications are categorized into two groups and displayed separately on the news configuration page. A first group includes news channels that are selected as favorite and a second group includes all other news channels that provide notification.

The news application also provides a novel method of suppressing extraneous notifications for the same event. News publishers that deliver an article to the device's news application client can indicate whether they want to send notifications for the article. The news application, in some embodiments, receives an identifier along with a notification from the news publishers.

In addition to the news application, a user can install news applications from one or more news publishers. When the device has also installed a publisher's news application, the device may get multiple notifications for the same article from the client news application of the device as well as the news application of the article's publisher. The news application in some embodiments stores identification of notifications and uses the stored notification identifications to suppress duplicative notifications.

Some embodiments provide different methods to allow a user to acquire or renew subscriptions to different news channels. The subscription process does not negatively impact the reading experience for non-subscribers. Some embodiments provide a GUI to enable a user to subscribe to a news channel through the news application while using the news application to read articles. The news application allows authentication of existing subscriptions acquired through third party subscription. Some embodiments provide subscription promotion while a user is using the news application.

One of ordinary skill will realize that the preceding Summary is intended to serve as a brief introduction to some inventive features of some embodiments. Moreover, this Summary is not meant to be an introduction or overview of all-inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF DRAWINGS

The novel features of the invention are set forth in the appended claims. However, for purposes of explanation, several embodiments of the invention are set forth in the following figures.

FIG. 1 conceptually illustrates a GUI for configuring news notifications in some embodiments.

FIG. 2 conceptually illustrates a process for configuring news notifications in some embodiments.

FIGS. 3A-3B conceptually illustrate an alternative method of enabling or disabling notifications for news channels in some embodiments.

FIG. 4 conceptually illustrates an alternative method of enabling or disabling notifications for news channels in some embodiments.

FIG. 5 conceptually illustrates a GUI in some embodiments for enabling notifications for a favorite news channels that did not previously support notifications but now supports notifications.

FIG. 6 conceptually illustrates a GUI for enabling notifications for several favorite news channels that did not previously support notifications but now support notifications.

FIG. 7 conceptually illustrates a process for suppressing duplicative news notifications in some embodiments.

FIG. 8 conceptually illustrates a device in locked mode in some embodiments.

FIGS. 9A-9B conceptually illustrate the use of short and long notifications in home screen in some embodiments.

FIGS. 10A-10B conceptually illustrate a news notification center in some embodiments.

FIGS. 11A-11C conceptually illustrate the news subscription purchase flow in some embodiments.

FIGS. 12A-12B conceptually illustrate the news subscription purchase flow in some embodiments.

FIGS. 13A-13B conceptually illustrate the news subscription purchase flow for confirming an existing subscription in some embodiments.

FIG. 14 conceptually illustrates providing a promotion advertisement to offer news subscription in some embodiments.

FIG. 15 conceptually illustrates providing a promotion advertisement to offer news subscription in some embodiments.

FIG. 16 conceptually illustrates providing a promotion advertisement to offer news subscription when a shred article is displayed on a non-subscriber device in some embodiments.

FIG. 17 conceptually illustrates automatic news subscription detections in some embodiments.

FIG. 18 conceptually illustrates a GUI for offering a user to renew an expired subscription in some embodiments.

FIG. 19 conceptually illustrates a GUI for offering a user to renew an expired subscription through a publisher's server in some embodiments.

FIGS. 20A-20B conceptually illustrate a process for providing subscription to news channels in some embodiments.

FIG. 21 is an example of an architecture of a mobile computing device in some embodiments.

FIG. 22 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a news client application for electronic devices such as smartphones, touchpads, laptops, computers, etc., that allows readers customize the topics they are interested in, create a list of favorite news channels, explore different news topics, search for specific news items, and read news articles. The news application provides tools for a user to control the news channels that are allowed to provide news notifications. Notifications provide alerts for breaking news, big events, developing stories and so on.

The news application provides several different novel methods for controlling which channel is allowed to provide news notifications. A notification configuration page allows notification from individual news channels to be turned on or off. The news channels that provide notifications are categorized into two groups and displayed separately on the news configuration page. A first group includes news channels that are selected as favorite and a second group includes all other news channels that provide notification.

The news application also provides a novel method of suppressing extraneous notifications for the same event. News publishers that deliver an article to the device's news application client can indicate whether they want to send notifications for the article. The news application, in some embodiments, receives an identifier along with a notification from the news publishers.

In addition to the news application, a user can install news applications from one or more news publishers. When the device has also installed a publisher's news application, the device may get multiple notifications for the same article from the client news application of the device as well as the news application of the article's publisher. The news application in some embodiments stores identification of notifications and uses the stored notification identifications to suppress duplicative notifications.

Some embodiments provide different methods to allow a user to acquire or renew subscriptions to different news channels. The subscription process does not negatively impact the reading experience for non-subscribers. Some embodiments provide a GUI to enable a user to subscribe to a news channel through the news application while using the news application to read articles. The news application allows authentication of existing subscriptions acquired through third party subscription. Some embodiments provide subscription promotion while a user is using the news application.

Some embodiments provide a leaky paywall mechanism to acquire new subscription. Non-subscribers are allowed to read a predetermined number of shared articles before being required to purchase subscriptions. Some embodiments provide a visual indication to the users in news feed that they are seeing their subscription content.

Several more detailed embodiments of the invention are described below. Section I describes providing notifications for news articles. Section II describes managing subscriptions to different news channels. Finally, Section III describes an electronic system with which some embodiments of the invention are implemented.

I. Providing Notifications for News Articles

Some embodiments provide a graphical user interface (GUI) that provides different methods of configuration notifications for news channels. The GUI allows display of notifications in locked mode. The GUI also provides short form and long form notifications to allow a reader to preview different portions of an article to decide to read the full article.

A. Enabling and Disabling of Notifications for News Channels

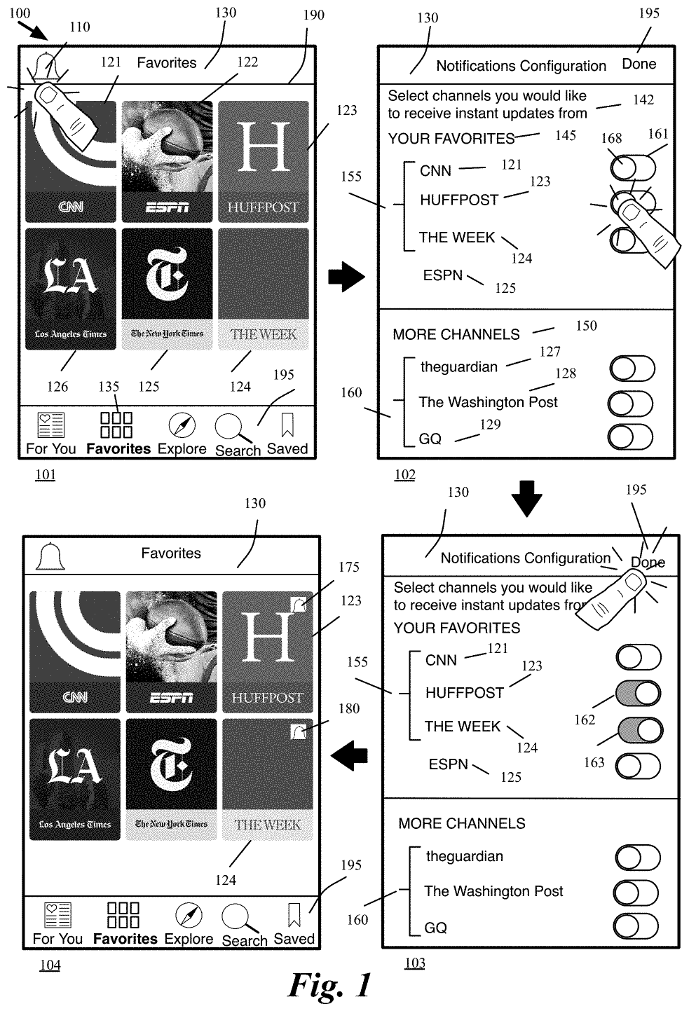

FIG. 1 conceptually illustrates a GUI for configuring news notifications in some embodiments. The GUI 100 in some embodiments is provided by a news application that executes on a device and allows a user to selectively enable and disable the display of news notifications from different news channels. The news application, in some embodiments, controls the display of news notifications and only displays notifications from channels for which the user has enabled notifications.

The figure is shown in four stages 101-104. The GUI includes a status bar 130, a channel view 190, and a toolbar 195. The channel view 190 is just one of the different views that the news application displays for a user. The toolbar 195 includes icons for performing various operations in the news application, such as viewing different feeds and articles, viewing saved articles, searching for news, and exploring available news articles.

As shown in stage 101, the favorites icon 135 in the tool bar is highlighted and the status bar 130 also indicates favorites. In some embodiments, the news application is for viewing articles and other content that is provided by a variety of sources regarding a variety of different topics. The user selects various different sources and topics to add to their favorites collection based on their interests. The news application then retrieves content from the various sources and content related to the various topics, and presents different views (e.g., feed views, article views, etc.) of the content to the user. As shown in stage 101, the favorite channels selected by the user include channels 121-126.

The status bar 130 also shows an icon 110 for configuring news notification. In stage 101, the user selects icon 110. The selection causes GUI 100 to show a notifications configuration page in stage 102. The notifications configuration page displays a bifurcated list of news channels that provide notifications and allows (as indicated by 142) the user to enable or disable notifications for different news channels.

The bifurcated list includes two groups of channels 155 and 160 that provide notifications. The GUI visually identifies (as shown by 145 and 150) the two groups of channels. Channels in the first group 155 are channels in the user's favorite list that currently provide notifications. Channels in the second group 160 are channels that are not in the user's favorite list that provide notifications. If the channels in either group cannot be displayed in the current viewport, the user can scroll the display up and down to see the rest of the channels. A viewport is the part of a displayed page that the user can currently see.

In the example of FIG. 1, each channel has a radio button (e.g., news channel 121 has radio button 161) that is used to enable or disable news notifications for the channel. The radio button uses different colors and/or the position of the selector 168 on the radio button to show whether notifications are enabled or disabled for a channel. In stage 102 all radio buttons have a color and/or position that indicates the notifications are disabled for the channels. However, as described below, radio buttons 162 and 163 have a different color in stage 103 to indicate notifications for these channels are enabled.

Other embodiments utilize different methods to enable and disable channel notifications. For instance, show embodiments allow a user to tap (or click or otherwise select) a channel to toggle notification status from enabled to disabled. Also some embodiments use a mark (such as a check mark), different colors, different shades, different highlights, different fonts, etc., to visually identify the notifications are enabled or disabled for a channel.

In this hypothetical example, favorite channels 121-124 currently provide notifications while favorite channel 125 does not provide notifications and is not included in the list 155. Also, channels 127-129 that are not in the favorite list provide notifications. Stage 102 also shows that the user has not yet selected any of these favorite channels to see their notifications and is about to select one for more channels to provide notifications.

Stage 103 shows that the user has selected channels 123 and 124. These are channels that the user wants the news application to display their notifications. As shown, radio buttons 162 and 163 in front of these channels has changed color to visually indicate to the user that notifications from these channels are enabled and will be displayed by the news application. A user can disable notifications by changing the position of the radio buttons for any of these channels again.

In stage 103, the user selects icon 195 to exit the notification configuration page. In stage 104, the list of favorite channels is displayed. As shown, the two favorite channels 123 and 124 for which notifications were enabled are badged by icons 175 and 180, respectively. The user can change the notification configuration again by either selecting icon 110 or any of the badges 175 and 180. Selection of either of the badges 175 and 180 takes the user back to the notification configuration page with the respective channel in view. For instance, if the favorite list 155 has many entries, selection of badge 175 displays configuration notification page with channel 123 in view.

Some embodiments allow news publishers to customize icons and/or instructions text in notification dialogs. When the user enables notifications for any of channels in group 160 (i.e., channels that are not currently in favorites list), some embodiments automatically add the channels to the favorite list.

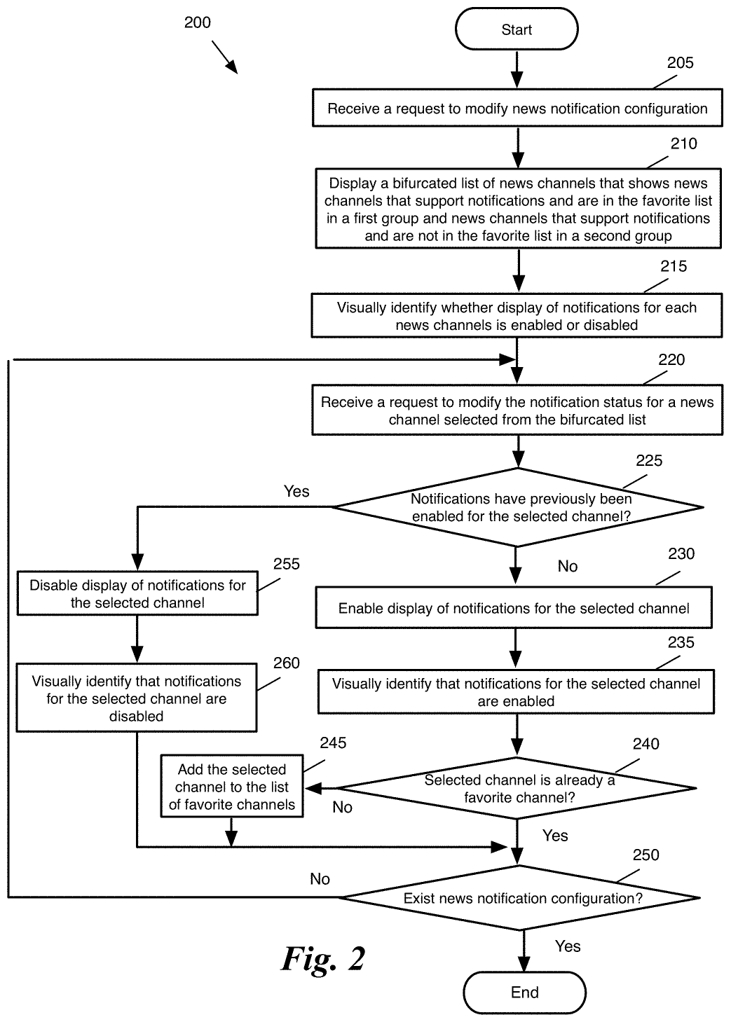

FIG. 2 conceptually illustrates a process 200 for configuring news notifications in some embodiments. The process in some embodiments is performed by a news application that executes on a device. As shown, the process receives (at 205) a request to modify news notification configuration. For instance, the process receives the selection of icon 100 as shown in FIG. 1.

The process then displays (at 210) a bifurcated list of news channels that shows news channels that support notifications and are in the favorite list in a first group and news channels that support notifications and are not in the favorite list in a second group. For instance, the process displays the two groups 155 and 160 of news channels as shown in stage 102 in FIG. 1. In some embodiments (as shown the embodiments shown in FIG. 1), the two groups are separated and displayed in different portions of the screen. In other embodiments, the channels in each group may be visually identified by different colors, different highlights, or different fonts.

The process also visually identifies (at 215) whether display of notification for each news channel is enabled or disabled. For instance, the process uses the color of a radio button (such as color of radio button 161-163 in FIG. 1) that is used to change the notification status of a channel to identify whether the notifications for the channel is enabled or disabled. In some embodiments, the process uses other techniques such the use of an icon next to each channel, different color, different highlight, or different fonts to visually identify the channels for which the notifications are enabled or disabled.

The process then receives (at 220) a request to modify the notification status (or preference) for a news channel selected from the bifurcated list. For instance, the process receives a selection of one of the displayed channels as shown in stages 102 and 103 in FIG. 1. The process then determines (at 225) whether the notifications for the selected news channel have previously been enabled. If yes, the process proceeds to 255, which is described below.

Otherwise, the process enables (at 230) display of notifications for the selected channel. The process also visually identifies (at 235) that notifications are enabled for the selected channel. For instance, the process enables notifications for channel 123 and visually identifies the color of the corresponding radio button 162 as shown in FIG. 1. The process then determines (at 240) whether the selected news channel is already a favorite channel. For instance, channels that are displayed in group 155 in FIG. 1 are already among the favorite channels.

If the selected channel is already a favorite channel, the process proceeds to 250, which is described below. Otherwise, the process automatically adds (at 245) the selected channel to the favorite channels. The process then proceeds to 250, which is described below. Some embodiments do not automatically add such a channel to the favorite list. In these embodiments, operations 240 and 245 are not performed. Also, the process in some embodiments does not immediately relocate a channel from the second group 160 to the first group 155 while the GUI still displays the configuration notification page. In these embodiments, once the notification configuration is exited and the favorite channels are displayed (e.g., in stage 104) channels in group 160 for which notifications are enabled are displayed as favorite channels.

The process determines (at 250) whether to exit news configuration. For instance, the process determines whether the user has selected icon 195 as shown in stage 103 in FIG. 1. If not, the process proceeds to 220, which was described above. Otherwise, the process ends.

When the notifications have previously been enabled for the selected channel, the process disables (at 255) the display of news notifications for the selected channel. The process also visually identifies (at 260) that notifications for the selected channel are disabled. For instance, the process changes the color of the radio button corresponding to the channel or otherwise changes the color, highlight, or the font of the displayed channel to indicate the notifications are disabled for the channel. The process then proceeds to 250, which was described above.

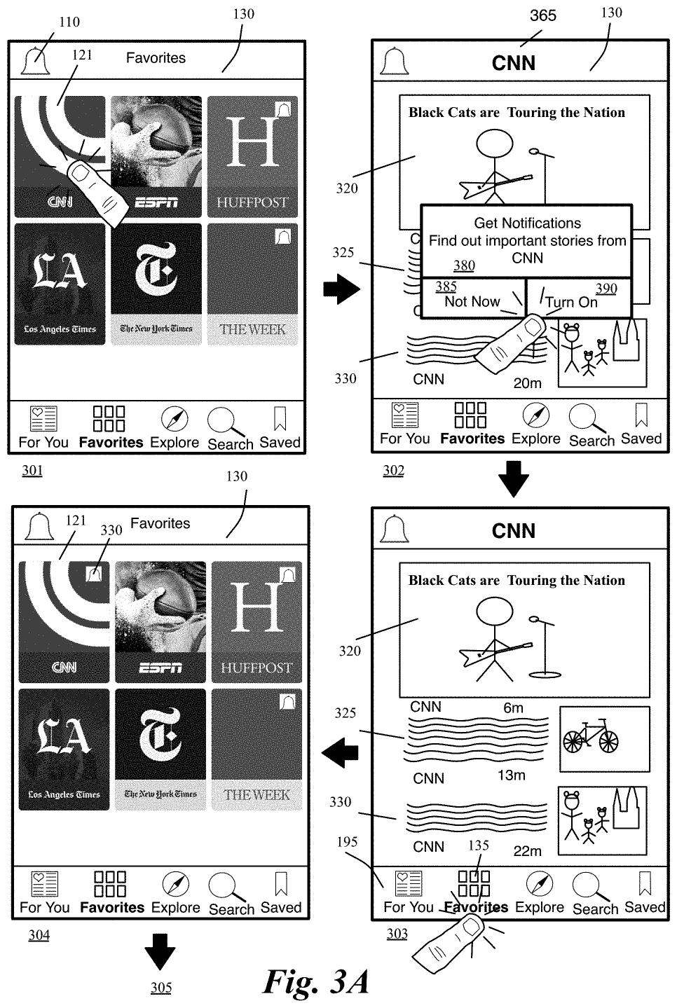

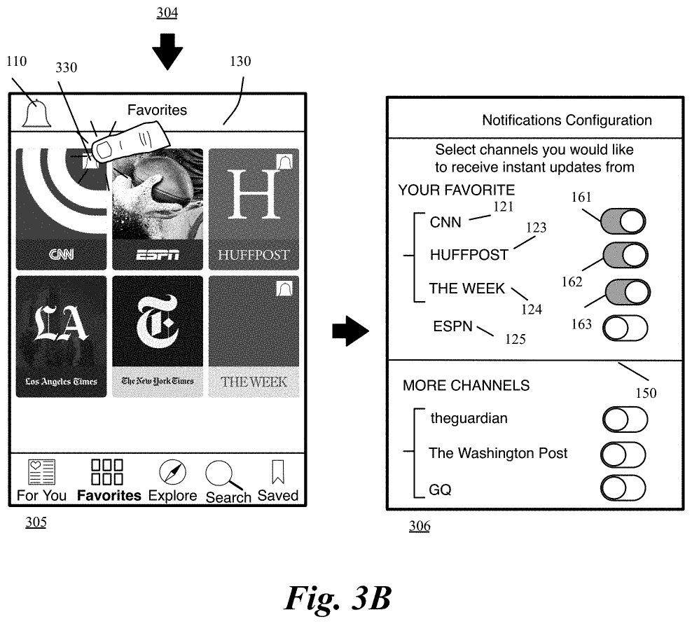

FIGS. 3A-3B conceptually illustrate an alternative method of enabling or disabling notifications for news channels in some embodiments. The figures show a GUI in six stages 301-306. In stage 301, the GUI shows the favorite channels. The user in stage 301 selects a favorite channel 121 for which notifications are not enabled by the user. As shown, the selected channel 121 is not badged to indicate the notifications for the channel are enabled.

In stage 302, the name 365 of the selected channel is displayed in the status bar 130 and a summary of one or more articles 320-330 that are provided by that channel are displayed. In stage 302 an alert 380 is displayed that offers to turn the notifications on for the currently displayed channel. The user is provided by an option 390 to enable notifications for the channel and another option 385 to refuse the offer. In this example, the user has selected option 390 to enable notifications.

In stage 303, the summary of the news articles 320-330 in the selected channel is displayed. The user can leave the channel by selecting any of the icons in the tool bar 195. In this example, the user has selected icon 135 to display the list favorite channels. As shown, channel 121 is now badged (as shown by 330) to indicate that notifications are enabled for the channel.

In stage 305, badge 330 is selected. As shown in stage 306, the notification configuration is displayed with channel 121 in view (e.g., if there are many favorite channels that provide notifications, the displayed is automatically scrolled to show channel 121). Since the notifications are already enabled for channel 121 (as shown in stage 302), the radio button 161 is displayed with a color or highlight that indicates the notifications for the channel is enabled.

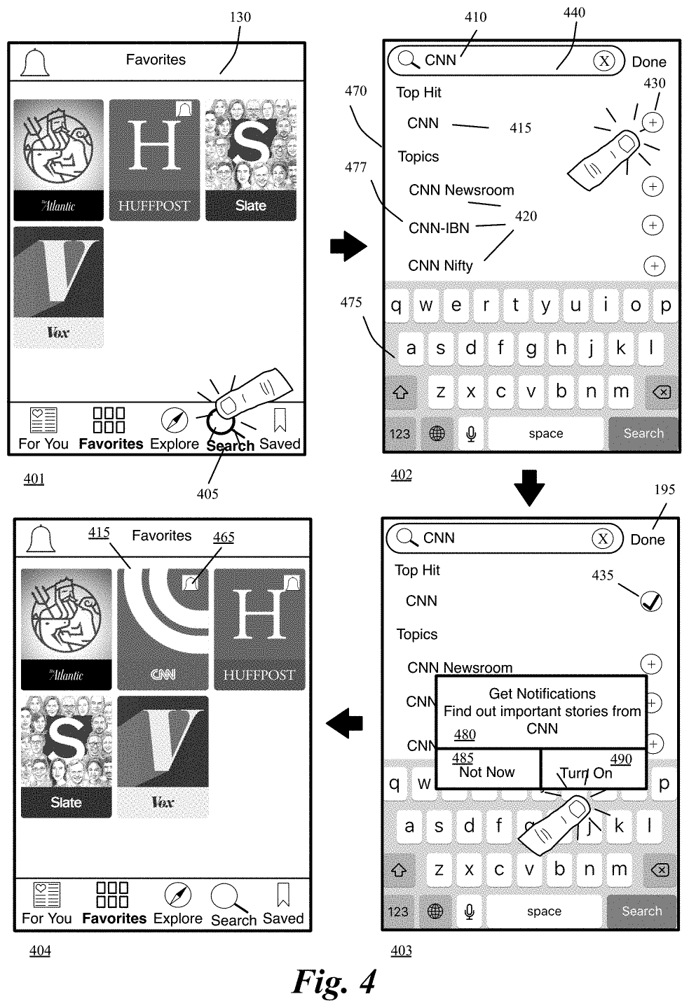

FIG. 4 conceptually illustrates an alternative method of enabling or disabling notifications for news channels in some embodiments. The figure shows a GUI in four stages 401-404. In stage 401, the GUI shows the favorite channels. The user in stage 401 selects icon 405 to search for different news items.

In stage 402 a search page 470 is displayed. The search page provides a region 440 for the user to enter the search criteria. If the device includes a touchscreen, the search page also displays a keyboard 475 for the user to enter the search criteria. As shown, the user has entered a search criteria 410 and the GUI has displayed a list of related information 477 for the search criteria. The information includes several news channels 415-420. The user in stage 402 has selected button 430 to add news channel 415 to the list of favorite news channels.

In stage 403, the selected channel is identified (e.g., by icon 435) as a channel that is selected as a favorite. The GUI also displays an alert 480 to provide the user with an option 490 to enables notifications for the selected channel. The user is also provided with an option 485 to refuse the offer. In this example, the user selects option 490 to enable notifications for channel 415.

In stage 404, the favorite channels are displayed (e.g., after the user selects icon 195 in stage 403). As shown in stage 404, channel 415 is added to the favorites list and is badged with icon 465 to indicate that notifications are enabled for this news channel.

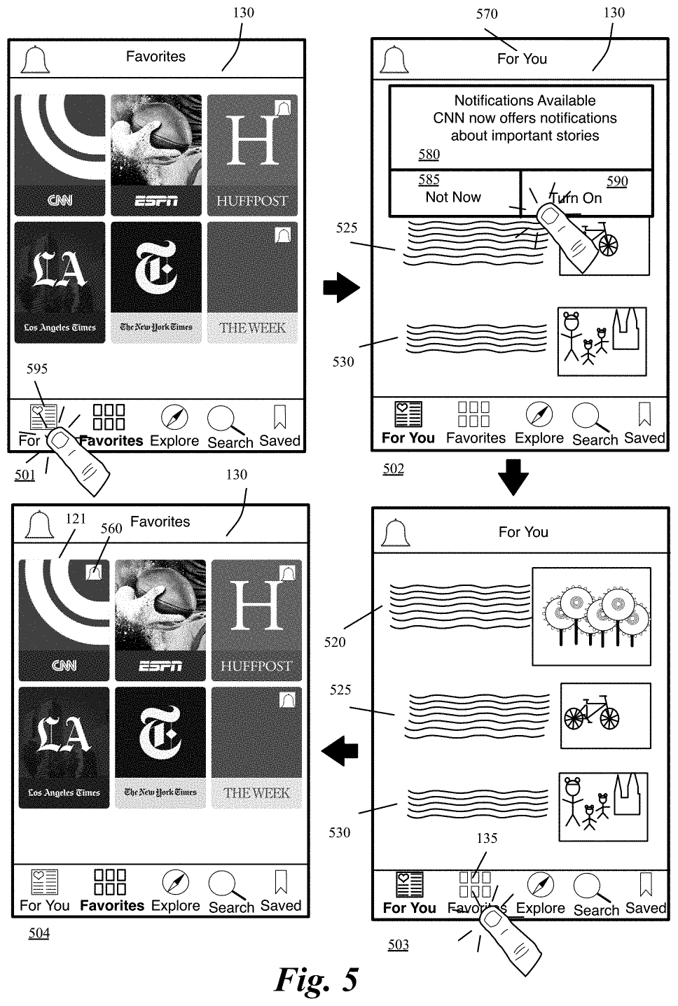

FIG. 5 conceptually illustrates a GUI in some embodiments for enabling notifications for a favorite news channels that did not previously support notifications but now supports notifications. The figure shows the GUI in four stages 501-504. In stage 501, the GUI shows the favorite channels. The user in stage 501 selects icon 595 to display a feed of news articles that are collected by the news application based on the user's favorite channels.

In stage 502, the name 570 of the feed is displayed in the status bar 130 and a summary of several articles 525-530 from different favorite channels is displayed. In this hypothetical example, the GUI also displays an alert 580 to provide the user with an option 590 to enable notifications for a particular news channel that previously did not support notifications but has started supporting notification.

The user is provided with a customized notification 580 to enable notifications for a particular channel. Some embodiments allow news publishers to provide custom made notifications to enable notifications. As shown, the user has selected option 590 to enable notifications for the particular channel.

In stage 503, the summary of different articles 520-530 is displayed to allow the user to review them and select articles to read. In this stage, the user selects icon 135 to display the list of favorite channels. In stage 504, the list of favorite channels is displayed. As shown, the particular channel 121 is badged by icon 560 to visually identify that notifications are enabled for the channel.

Although the example of FIG. 5 shows the notification 580 displayed while the user is reading a particular channel 570, the news application in some embodiments displays the notification 580 in any other displays (e.g., favorites as shown in stage 501 or search as shown in stage 402 in FIG. 4, etc.) provided by the news application as soon as a favorite news channel is detected to start supporting notifications.

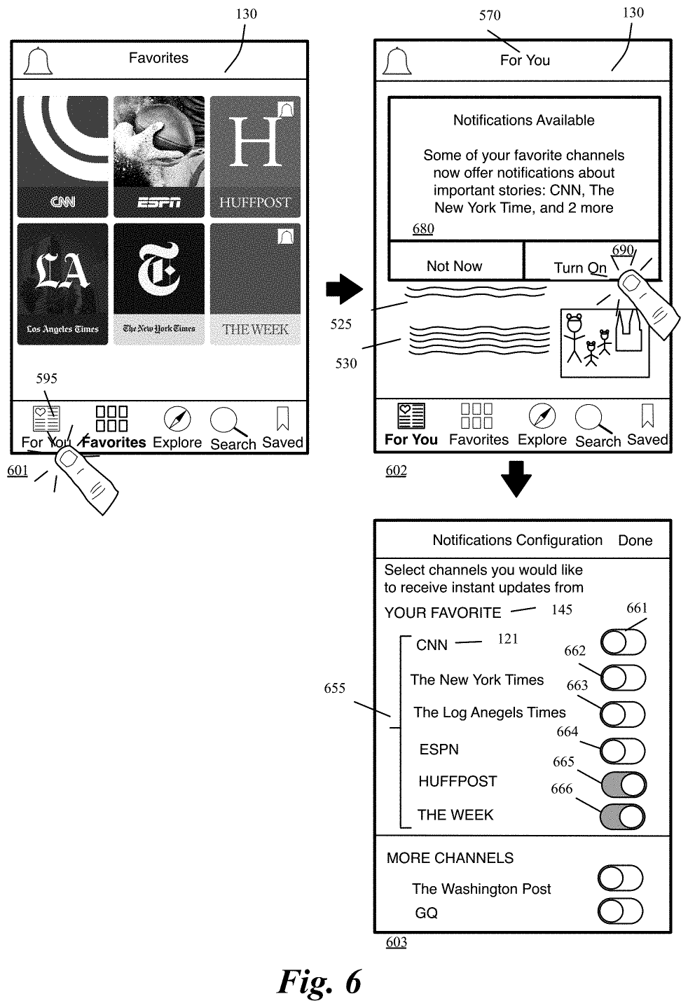

FIG. 6 conceptually illustrates a GUI for enabling notifications for several favorite news channels that did not previously support notifications but now support notifications. The figure shows the GUI in three stages 601-603. In stage 601, the GUI shows the favorite channels. The user in stage 601 selects icon 595 to display a feed of news articles that are collected by the news application based on the user's favorite channels.

In stage 602, the name 570 of the feed is displayed in the status bar 130 and a summary of several articles 525-530 from different favorite channels is displayed. In this hypothetical example, the GUI also displays a notification 680 to provide the user with an option 690 to enable notifications for several news channels that previously did not support notifications but have started supporting notification.

As shown, the user has selected option 690 to enable notifications for the particular channel. Since there are several news channels that started providing notifications and the user may only want to enable notifications for some of these favorite channels, the GUI display the notification configuration page in stage 603 in order to allow the user to individually enable or disable notifications for different news channels.

In stage 603, the favorite news channels that provide notifications are displayed. Notification for some of these news channels is disabled as shown by the color or highlight of radio buttons 661-664. As shown by the color or highlight of radio buttons 665-666, the list 655 of favorite channels that provide notification also includes several favorite channels for which notifications have previously been enabled.

B. Suppressing Duplicative Notifications

Some embodiments identify duplicative notifications for the same news article and suppress the extraneous notifications. In addition to the news application, a user can install news applications from one or more news publishers. When the device has also installed a publisher's news application, the device may get multiple notifications for the same article from the news application client of the device as well as the news application of the article's publisher.

The news application client in some embodiments is a native application that is installed as a set of default applications along with the device operating system while publishers' applications are third party applications, which can be added or deleted by the user. The news application in some embodiments stores identification of notifications and uses the stored notification identifications to suppress duplicative notifications.

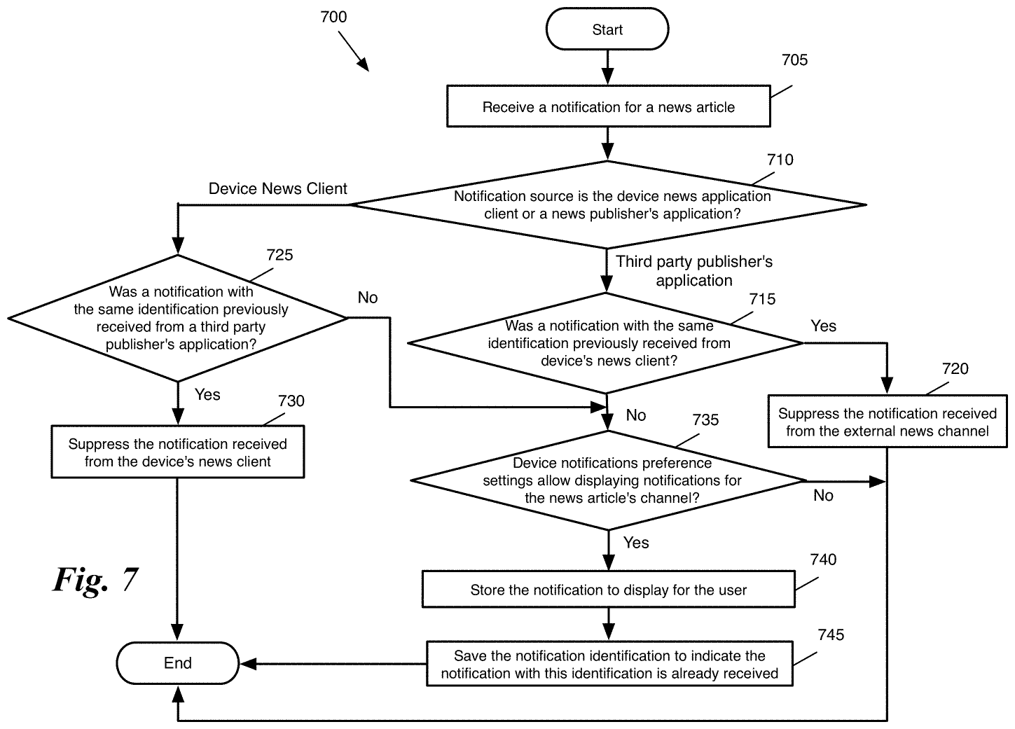

FIG. 7 conceptually illustrates a process 700 for suppressing duplicative news notifications in some embodiments. The process in some embodiments is performed by a device's client news application. As shown, the process receives (at 705) a notification for a news article. Each notification in some embodiments includes a unique identification. For instance, the unique identifier can be a unique sting or a set of strings that identifies the article's news channel and a string that uniquely identifies notifications for that news channel.

The process then determines (at 710) whether the notification source is the device news client or a third part news publisher's application. In some embodiments, a third party publisher's news application provides the news notifications to a news notification center provided by the device news application client. If the notification was received from a publisher application, the process proceeds to 715, which is described below.

Otherwise, when the notification is received from the device news client, the process determines (at 725) a notification with the same identification was previously received from a third party publisher's application. If not, the process proceeds to 735, which is described below. Otherwise, the process suppresses (at 730) the notification received from the device news client as a duplicative notification. The process then ends.

When the notification is received from a third party publisher's application, the process determines (at 715) whether a notification with the same identification was previously received from device's news client. If yes, the process suppresses (at 720) the notification provided by the publisher's news application. The process then ends.

Otherwise, the process determines (at 735) whether the device notification preference settings allow displaying notifications from the article's news channel. For instance, as described in section I.A above, a user can selectively enable and disable notifications for different news channels. If the notifications are disabled for the article's news channel, the process ends. Otherwise, the process stores (at 740) the notification to display for the user. For instance, if the user is currently using the news application to read news, the process may immediately display the notification. Otherwise, the news application displays the notification when the user uses the news application in future.

The process also stores (at 745) the notification identification to indicate a notification with this identification is already received. The process utilizes the stored identification to determine (e.g., in operations 715 or 725) whether any future notifications have already been received. The process then ends.

C. Displaying Notifications in Locked Mode

Some embodiments provide notifications for news articles when the device is in locked mode. In some embodiments, the device has a touch-sensitive screen that allows touch interactions with the device's operating system and applications. This touch-sensitive screen can be locked to provide reduced or no touch functionality and thereby prevent unauthorized users from accessing the information on the device and/or to avoid an unintentional user interface selection. The device in locked mode can be unlocked, e.g., by providing a passcode and/or biometric information. In some embodiments, only a small set of controls can be used to provide input into the device in locked mode.

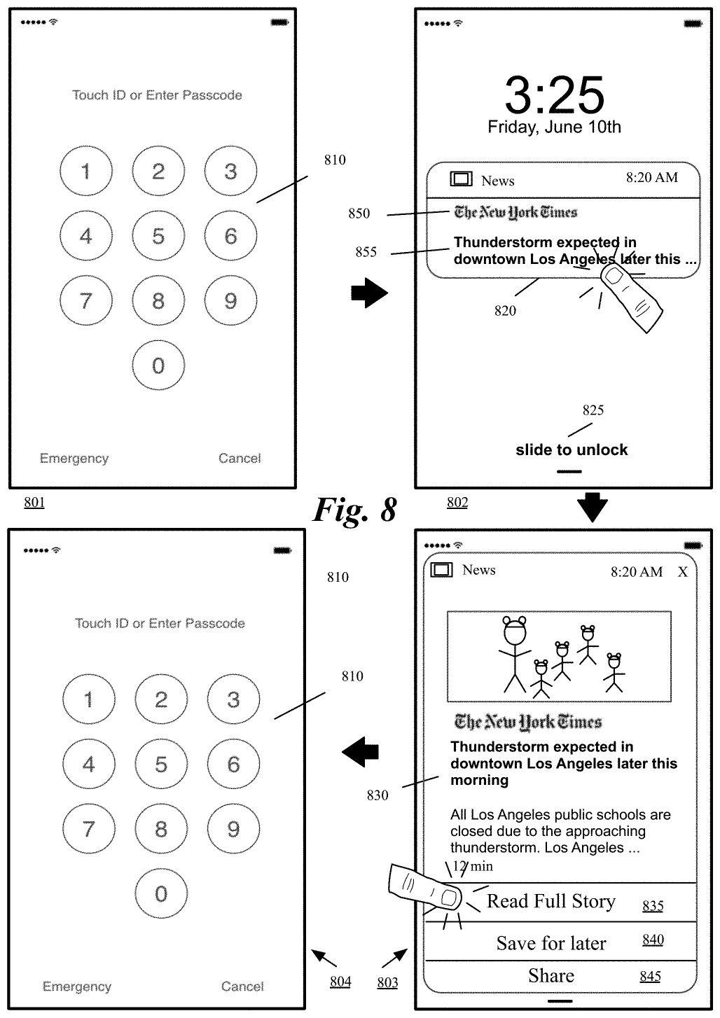

FIG. 8 conceptually illustrates a device in locked mode in some embodiments. The figure is shown in four stages 801-804. In stage 801, the device screen is locked and requires a passcode through the displayed keyboard 810 and/or biometric information such as a thumbprint through the device's integrated biometric reader (not shown).

In stage 802, a notification 820 for a news article is displayed on the locked screen. The notification displays the news channel name 850 and a short excerpt 855 of the article. In this example, the device display screen has a 3 dimensional (3D) touch (or forced touch) capability where the display screen is touch sensitive and senses the pressure applied to the display. As shown, the user provides a touch input anywhere in the vicinity of the notification 820. In some embodiments, the user can also use a hand gesture (e.g., drag the notification 820 down across the screen) to proceed to stage 803 to display a longer excerpt of the article.

In stage 803, a longer excerpt 830 of the article is displayed while the device is still in locked mode. Several options 835-845 are provided for the user to read the full article (option 835), to save the article for later (option 840), and to share the article (845).

Reading the full article 835 and sharing the article 845 require the user to enter a passcode or biometric information through an integrated biometric reader (not shown). Saving the article for later 840 in some embodiments does not require the device to be unlocked. In this example, the user has selected to read the full article. In stage 804, keypad 810 is provided to allow the user to enter a passcode to read the full article. In some embodiments, the user can also enter biometric information to unlock the device and read the article.

In some embodiments, the short version 820 of the article preview is provided by the article's publisher. The news application prepares the longer version of the article preview 830 from the body of the article based on the size, orientation, and resolution of the device.

D. Short and Long Notifications

Some embodiments provide a notification with a short summary for a news article. If the user is interested to see more about the article, the user can either use a gesture or provide a 3D touch to see a longer summary of the article.

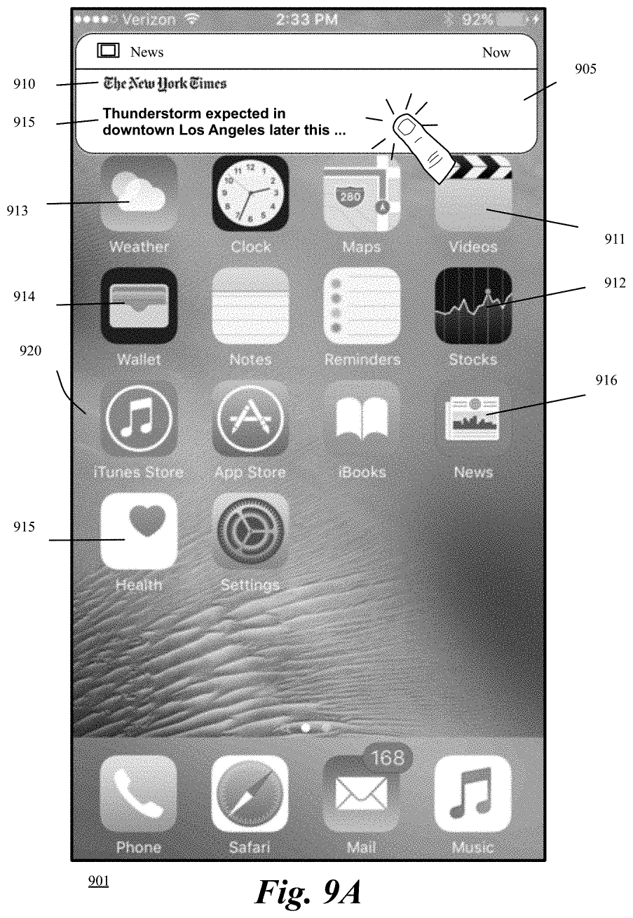

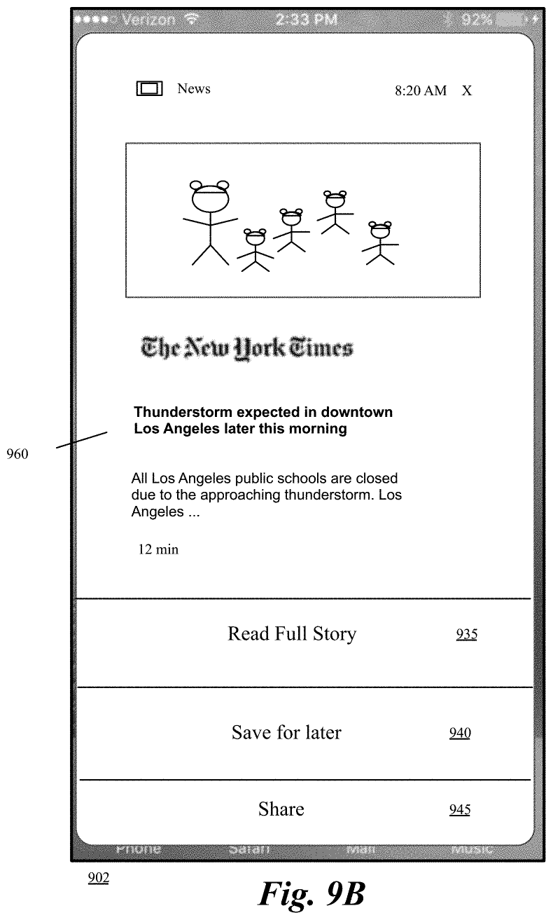

FIGS. 9A-9B conceptually illustrate the use of short and long notifications in home screen in some embodiments. The figures are shown in two stages 901 and 902. In stage 901, the home screen 920 is displayed. The home screen is a page that displays different applications 911-916 (including the news application 916) and allows a user to select and launch any of these applications. As shown, a notification 905 for a news article is displayed on the home screen 920. The notification displays the news channel name 910 and a short excerpt 915 of the article. In this example, the device display screen has a 3D touch capability. As shown, the user provides a touch input anywhere in the vicinity of the notification 905. In some embodiments, the user can also use a hand gesture (e.g., drag the notification 905 down across the screen) to proceed to stage 902 to display a longer excerpt of the article.

In stage 902, an expanded view 960 of the article summary is displayed. Several options 935-945 are provided for the user to read the full article (option 935), to save the article for later (option 940), and to share the article (945). FIGS. 9A-9B provide the same capability for switching from a short notification to a long notification with the difference that the notification in FIG. 8 are displayed while the device is in locked mode and the notifications are displayed at home screen in FIGS. 9A-9B.

In some embodiments, the short version 905 of the article preview is provided by the article's publisher. The news application prepares the longer version of the article preview 960 from the body of the article based on the size, orientation, and resolution of the device.

Some embodiments provide a news notification center. The news notification center in some embodiments is displayed when the user performs a gesture (e.g., a drag operation from the top towards the bottom of the screen. In other embodiments, the news notification center is displayed by selecting a control provided by the news application GUI.

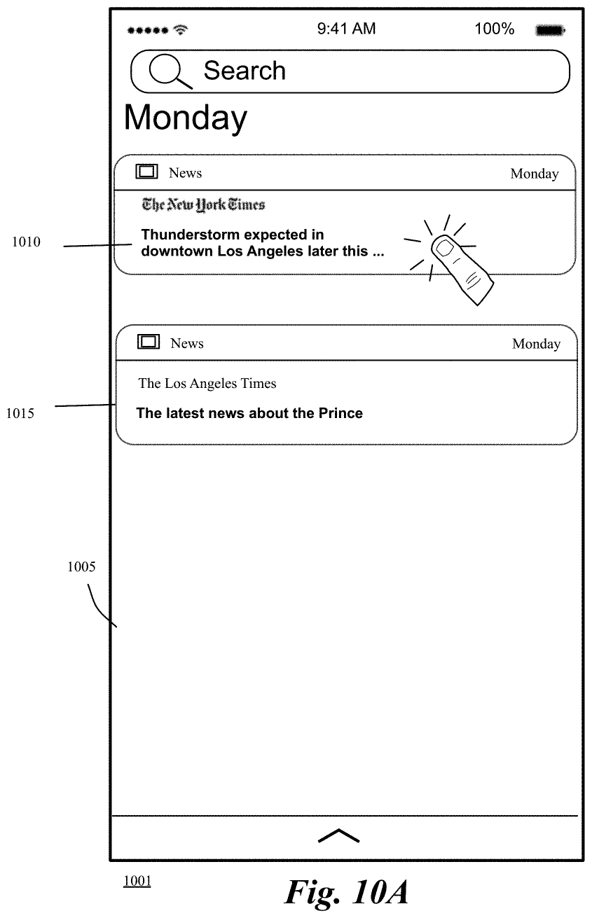

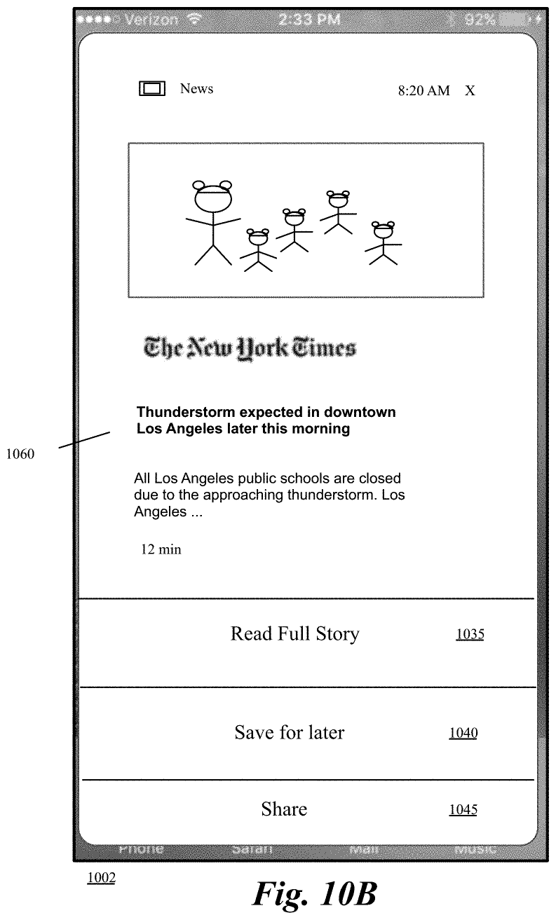

FIGS. 10A-10B conceptually illustrate a news notification center 1005 in some embodiments. The figures are shown in two stages 1001-1002. In stage 1001, the notification center includes several notifications 1010-1015 about different news articles. Similar to FIGS. 8 and 9A-9B, the user can either use a forced touch or a gesture to display a longer version of one of the notifications. In stage 1001, the user has selected to view a longer version of news article 1010 excerpt.

In stage 1002, a longer excerpt 1060 of the selected article 1010 is displayed. Several options 1035-1045 are provided for the user to read the full article (option 1035), to save the article for later (option 1040), and to share the article (1045).

II. Managing Subscriptions to News Channels

Some embodiments provide different methods to allow a user to acquire or renew subscriptions to different news channels. The subscription process does not negatively impact the reading experience for non-subscribers. Some embodiments provide a GUI to enable a user to subscribe to a news channel through the news application while using the news application to read articles. The news application allows authentication of existing subscriptions acquired through third party subscription. Some embodiments provide subscription promotion while a user is using the news application.

Some embodiments provide a leaky paywall mechanism to acquire new subscription. Non-subscribers are allowed to read a predetermined number of shared articles before being required to purchase subscriptions. Some embodiments provide a visual indication to the users in news feed that they are seeing their subscription content.

A. Offering Subscriptions

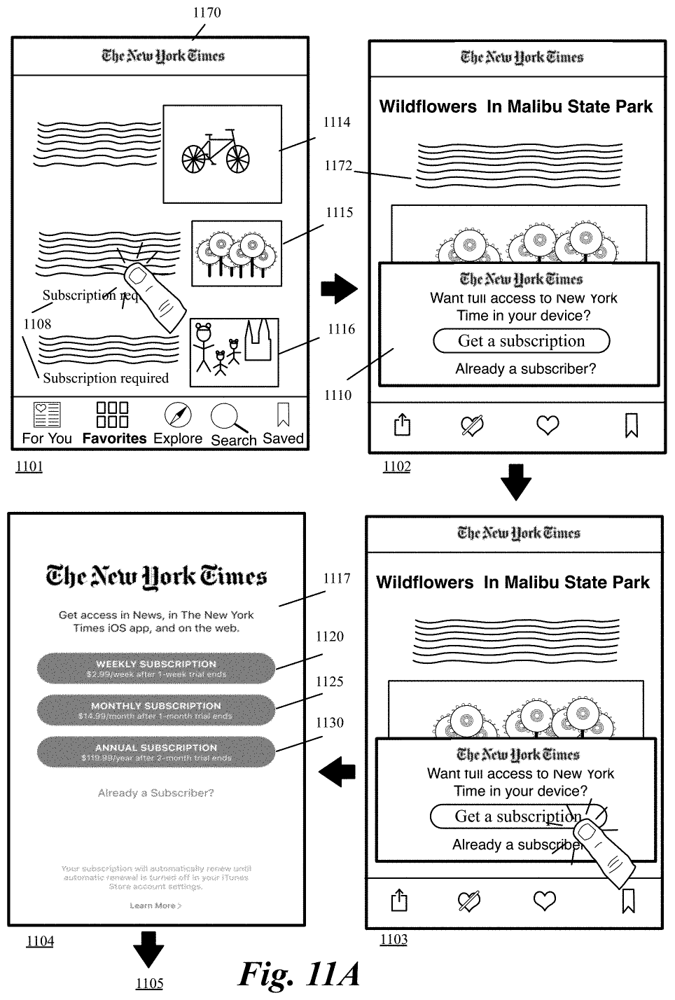

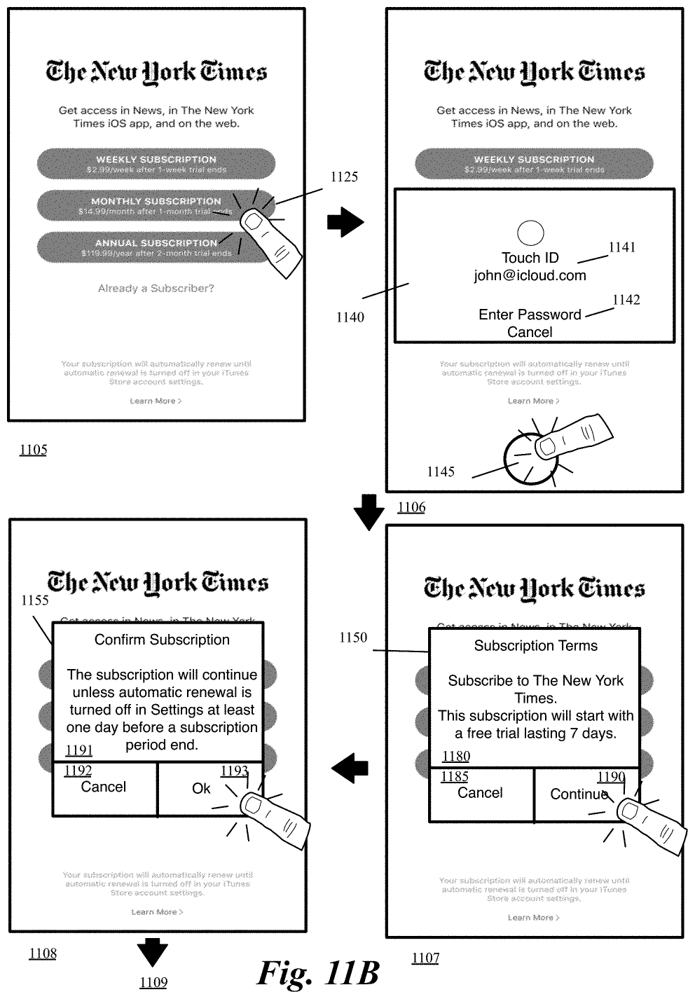

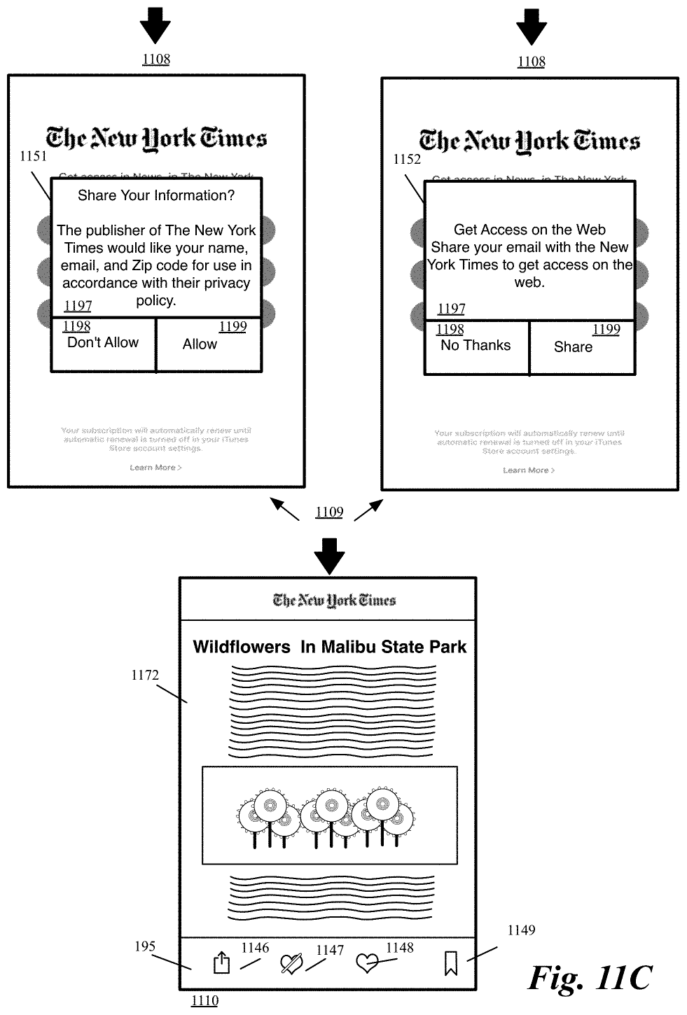

FIGS. 11A-11C conceptually illustrate the news subscription purchase flow in some embodiments. The figures show a GUI in ten stages 1101-1110. In stage 1101, several article summaries 1114-1116 of a favorite channel 1170 are displayed. As shown, some of the articles 1115-1116 require subscriptions. These articles are identified by a short label 1108 and/or an icon. As shown, the user has selected an article 1105 that requires subscription.

Stage 1102 displays the full article 1172 with a notification 1110 that the article requires subscription. Some embodiments allow a news publisher to provide custom made notification and subscription offers to the news application client. The news publisher can use a backend “newsroom” server to create a news channel and provide different customized notifications such as notification 1110, subscription offer 1117 in stage 1104, subscription terms 1150 in stage 1107, subscription confirmation 1155 in stage 1108, requests to share information 1151-1152 in stage 1109, etc. The news application receives the customized notifications and offers from the backend server and displays them when a subscription for the channel is required.

Despite the notification displayed over the article, some embodiments display the notification with a small height and allow the user to still interact with the article (e.g., to scroll the article up or down). In stage 1103, the user has selected to get subscription. In stage 1104, the GUI displays the subscription offer 1117 with different subscription options 1120-1130. Similar to notification 1110, some embodiments allows a news publisher to provide customized subscription offers to the news application when the news publisher is creating a channel. In stage 1105, the user has selected one of the subscription offers 1125.

Stage 1106 provides different options 1140 to confirm subscriptions. The user can either enter a password 1142 or enter biometric information 1141 through touch identification. As shown, the user has entered identification through a thumbprint reader 1145, which is integrated with the device.

Stage 1107 displays subscription terms 1150. The subscription terms includes the description 1180 of the subscription terms, an option 1190 to continue, and an option 1185 to cancel. The user in this example has selected the option 1190 to continue. In stage 1108, the user is requested (as shown by 1155) to confirm the subscription. The confirmation includes a description 1191, an option to accept 1193, and an option to cancel 1192. In this example, the user has selected to confirm the subscription.

In some embodiments, the news application provides the publishers with multiple options to request the user to share information. Two of these options 1151-1152 are shown in stage 1109. Depending on which option is selected by the publisher through the backend newsroom server, the news application displays the option selected by the publisher. Either of the offers 1151-1152 in this example includes a description 1197, an option to accept 1199, and an option to refuse 1198.

In stage 1110, the full article 1172 is displayed after the subscription is completed. As shown, the tool bar 195 includes a set of options to facilitate (sharing 1146, disliking 1147, liking 1148, and saving 1149) the reading of the full article.

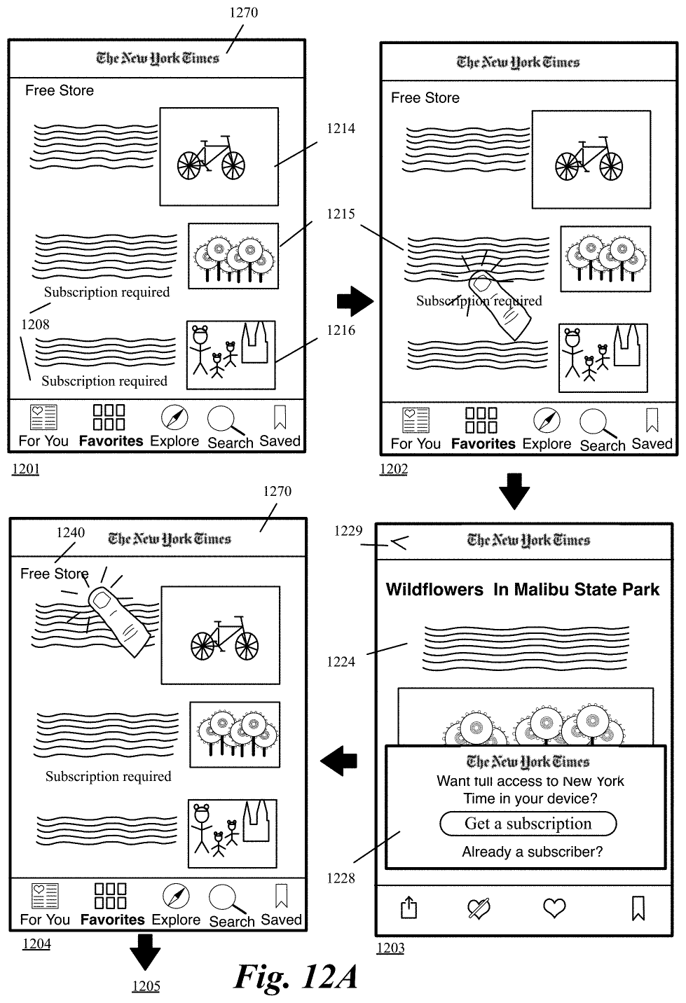

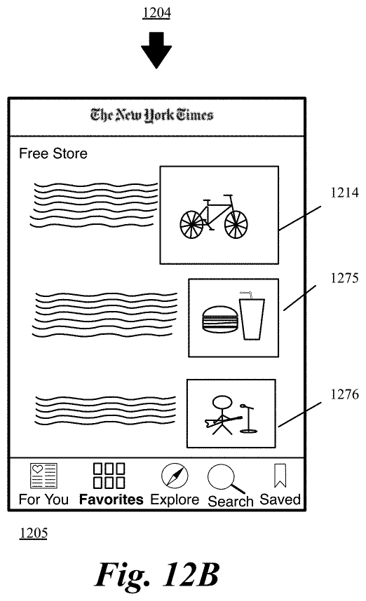

FIGS. 12A-12B conceptually illustrate the news subscription purchase flow in some embodiments. The GUI in the figures is shown in five stages 1201-1205. In stage 1201, several article summaries 1214-1216 of a favorite channel 1270 are displayed. The publisher, in some embodiments, can specify how the articles are arranged in the publisher's feed at the time that the publisher establishes a news channel through the backend newsroom server.

Some publishers may elect the news application client to organize the news articles of the channel into free articles, subscription only articles, or a mix of both. In the example of FIG. 12A, the free and subscription only articles are mixed. The articles that require subscription are identified by a short label 1208 and/or an icon. In stage 1202, the user has selected an article 1215 that requires subscription.

In stage 1203, displays the full article 1224 with a notification 1228 that the article requires subscription. This stage is similar to stage 1102 of FIG. 11 described above. In this example, the user has decided to not get a subscription. The user uses a back button 1229 to navigate back to previous screen. In stage 1204, the news feed for the channel 1270 is displayed again. As shown, the GUI provides an option 1240 to display only the articles that do not require subscription. In this example, the user has selected option 1240. In stage 1205, the only the news articles 1214 and 1275-1276 that do not require subscription are displayed.

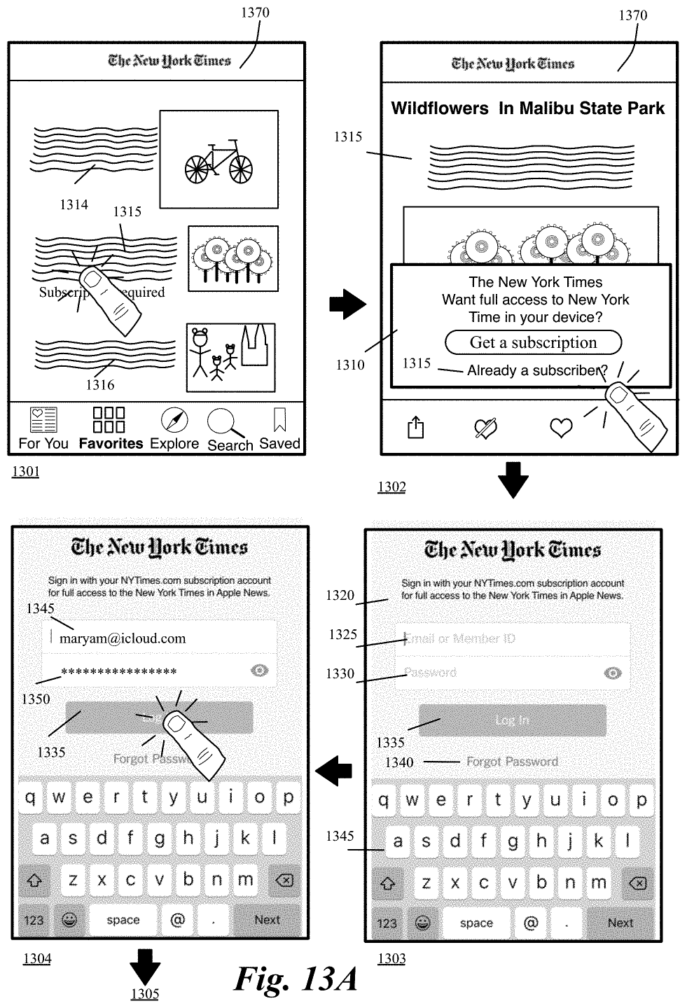

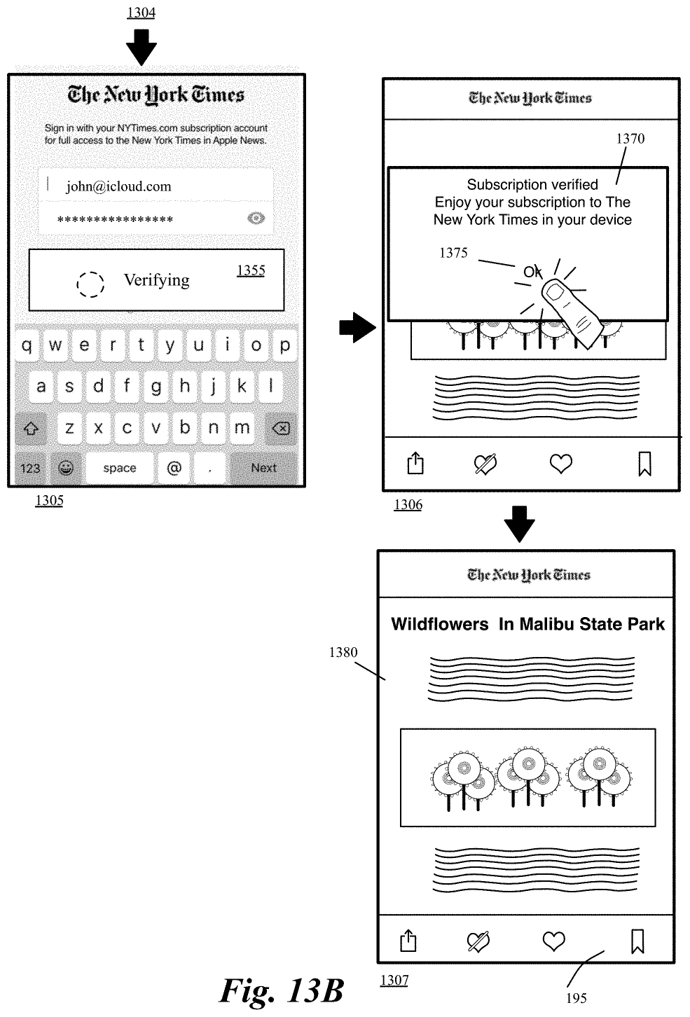

FIGS. 13A-13B conceptually illustrate the news subscription purchase flow for confirming an existing subscription in some embodiments. The GUI in the figures is shown in seven stages 1301-1307. In stage 1301, several article summaries 1314-1316 of a favorite channel 1370 are displayed. As shown, the user has selected an article 1315 that requires subscription.

In stage 1302, an offer 1310 to get a subscription to news channel 1370 is displayed. In this example, the user already has a subscription from the publisher of the channel and selects option 1315 to verify the subscription. In contrast to the example of FIGS. 11A-11C where the news application displayed subscription offer that was provided by the publisher, in the example of FIGS. 13A-13B, the user is redirected to the publisher's website (or server) to verify the subscription.

In stage 1303, the publisher's server displays a prompt 1320 to enter a user identification 1325 and a password 1330. The prompt also provide an option 1335 to login after the user identification and the password are entered. The prompt also provide an option 1340 to recover a forgotten password. A keypad 1345 is also displayed to enter the required information.

In stage 1304, the user enters the user identification 1345 and password 1350. The user then selects option 1335 to login. In stage 1305, the news application performs handshaking with the publisher's server to determine whether the user is authenticated and the subscription is verified. In stage 1305 a prompt 1355 is displayed to inform the user that the subscription is being verified. Once the subscription is verified by the publisher, the news application receives and stores the subscription information (e.g., in the form of an access token that does not include the user's “user identification” and password from the publisher) from the news publisher.

In stage 1306, the subscription verification 1370 is displayed. As shown, the user has selected the confirm option 1375. In stage 1307, the full article 1380 is displayed. As shown, the tool bar 195 includes a set of options to facilitate (e.g., sharing, making favorite, saving, etc.) the reading of the full article.

Some embodiments provide advertisement in different location by the news application to offer subscriptions for a news channel. Some embodiments display advertisements in the personalized feed (such as personalized feed 570 shown in FIG. 6). Some embodiments display advertisements in a publisher's news feed (such as news feed 1170 shown in FIG. 11A). Some embodiments display a subscription advertisement when a full article is displayed (e.g., full article display in stage 1307 in FIG. 13B).

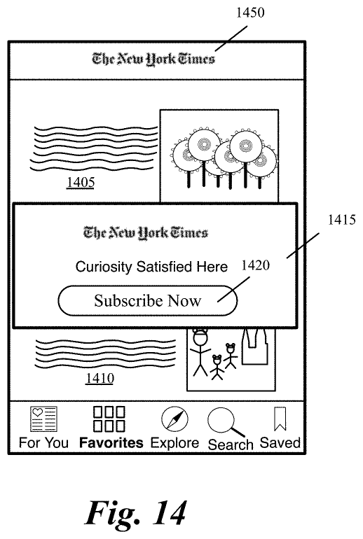

Some embodiments place a promotion placard on a shared article when the non-subscriber user receives the shared article from a subscriber. FIG. 14 conceptually illustrates providing a promotion advertisement to offer news subscription in some embodiments. As shown, summaries of several articles 1405-1410 are displayed in a news channel 1450. An advertisement 1415 is displayed that offers a promotion to subscribe to the news channel.

In some embodiments, the publisher of the channel provides different advertisement and different criteria for displaying the advertisement when the publisher uses the newsroom backend server to establish the channel. Acceptance 1420 of the offer will display different subscription options as described above by reference to stage 1104 in FIG. 11A.

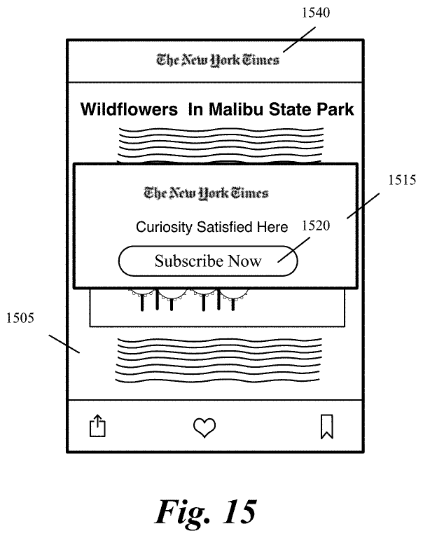

FIG. 15 conceptually illustrates providing a promotional advertisement to offer news subscription in some embodiments. As shown, a full article 1505 is displayed. An advertisement 1515 is displayed that offers a promotion to subscribe to the news channel 1540 of the article publisher.

In some embodiments, the publisher of the channel provides different advertisement and different criteria for displaying the advertisement when the publisher uses the newsroom backend server to establish the channel. Acceptance 1520 of the offer will display different subscription options as described above by reference to stage 1104 in FIG. 11A.

B. Shared Articles

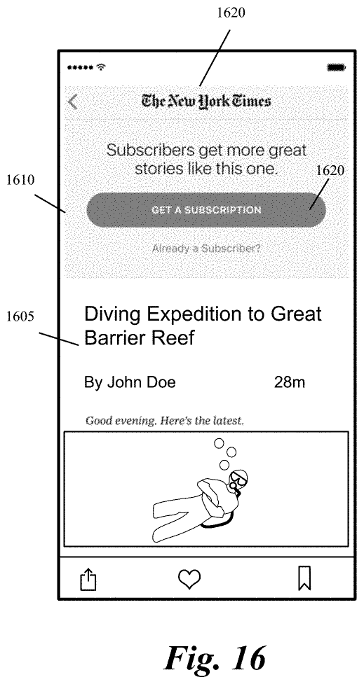

FIG. 16 conceptually illustrates providing a promotional advertisement to offer news subscription when a shred article is displayed on a non-subscriber device in some embodiments. As shown, a news article 1605, which is shared by a subscriber is displayed on a non-subscriber's device.

The reader is provided with a promotion offer 1610 to get subscriptions to the news channel 1620. In some embodiments, the publisher of the channel provides different advertisements for non-subscribers and different criteria for displaying the advertisement when the publisher uses the newsroom backend server to establish the channel. Acceptance 1620 of the offer will display different subscription options as described above by reference to stage 1104 in FIG. 11A.

Some embodiments provide a number of free accesses for the shared articles even if the user is not subscribed to a channel. For instance, some embodiments provide a periodic (e.g., monthly) maximum number of shared articles that require subscription and the user can read without subscription. This number is set in some embodiments per news channel while other embodiments set the maximum number as the aggregate for all news channels. As long as the maximum number of free access to shared articles is not exceeded, the user can read a shared article without subscription. For instance, the user can start scrolling the article and the offer to purchase the subscription either disappears or is reduced to a small notification on the top or the bottom of the screen. Once the maximum number is exceeded, the news application displays a hard paywall that will not restrict access to the article without subscription.

In some embodiments, the news application allows a publisher to opt out of the free shared article accesses. In these embodiments, when a shared article is published by a publisher that has opted out of providing the free access, a hard paywall is displayed on the first shared article from that publisher that requires subscription.

C. Subscription Detection

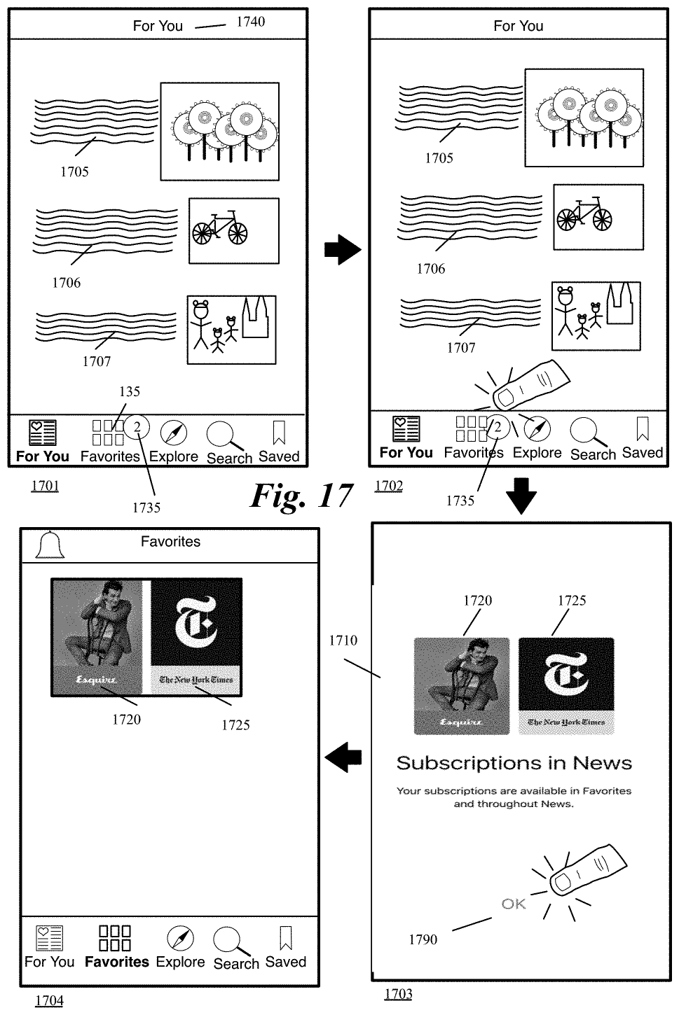

FIG. 17 conceptually illustrates automatic news subscription detections in some embodiments. The figure is shown in four stages 1701-1704. In stage 1701, a feed of news articles 1705-1707 that are collected by the news application based on the user's favorite channels is displayed.

In the first launch of the news application on the device, the news application scans the device and locates one or more of the device user's news subscriptions. The subscriptions are automatically (without requiring any input from the user) authenticated and the subscribed channels are added to the favorites list. As shown, the favorites icon 135 is badged 1735 by the number of subscriptions that are found. In subsequence launches, the favorites icon 135 is badged with the number of subscriptions since last launch of the news application.

In stage 1702 the badge 1735 is selected. In stage 1703 a subscription detection sheet 1710 is displayed. The icons for the available subscribed channels 1720 and 1725 are displayed. As shown, the user has selected the confirmation button 1790. Some embodiments do not display a confirmation button. In these embodiments, the user can navigate back to the previous page using a back button such as back button 1229 shown in FIG. 12. In stage 1704, the favorite channels are shown. The favorite channels include channels 1720 and 1725 for which the subscription is detected.

D. Subscription Renewal

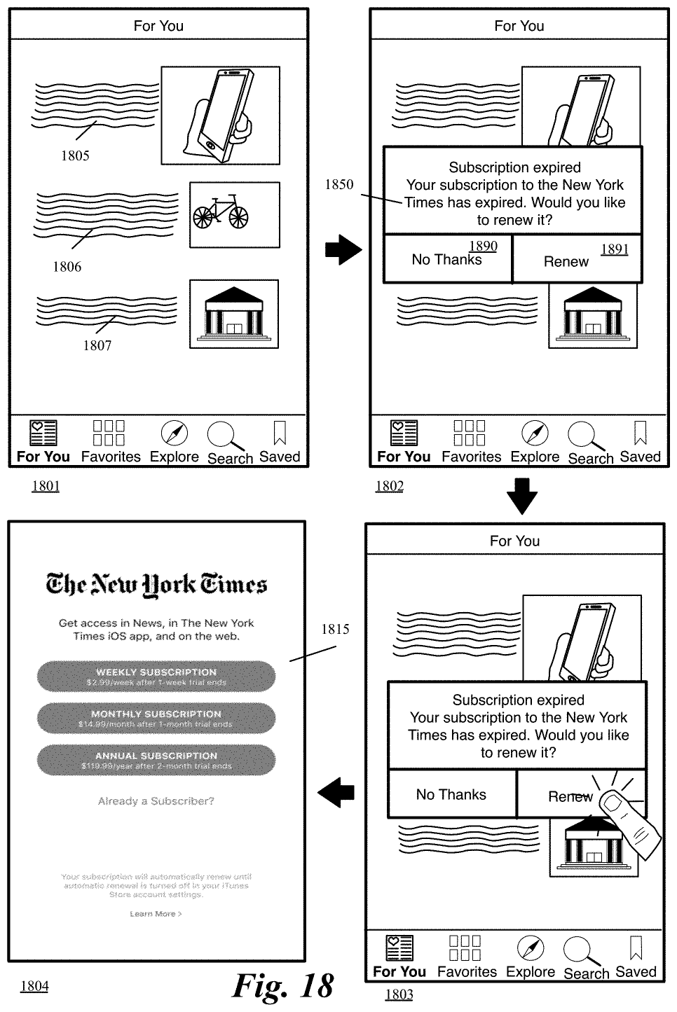

Some embodiments automatically detect expired subscriptions and offer the user to renew the subscriptions. FIG. 18 conceptually illustrates a GUI for offering a user to renew an expired subscription in some embodiments. The figure is shown in four stages 1801-1804. In stage 1801, a feed of news articles 1805-1807 that are collected by the news application based on the user's favorite channels is displayed. In stage 1802, the news application has detected that the user's subscription to one of the channels has expired. The GUI displays an offer 1850 to renew the expired subscription. The offer provides an option 1891 to accept the offer and another option 1890 to reject the offer.

In stage 1803, the user has accepted the offer to renew the subscription. In stage 1804, the subscription option sheet 1815 is displayed as described above by reference to stage 1104 in FIG. 11A. In some embodiments, when the user has multiple expired subscriptions, a dialog similar to 1850 is shown one after each other for each subscription. The same display as stage 1801 is maintained whether or not the user renews a subscription.

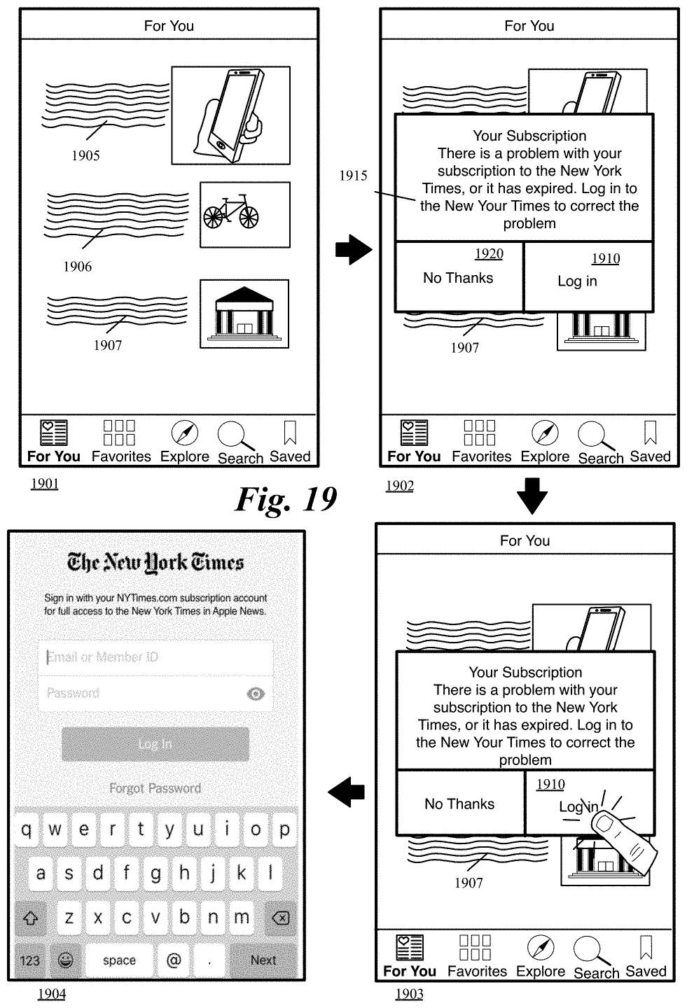

FIG. 19 conceptually illustrates a GUI for offering a user to renew an expired subscription through a publisher's server in some embodiments. The figure is shown in four stages 1901-1904. In stage 1901, a feed of news articles 1905-1907 that are collected by the news application based on the user's favorite channels is displayed. In stage 1902, the news application has detected that the user's subscription to one of the channels has expired. The GUI displays an offer 1915 to renew the expired subscription. The offer provides an option 1910 to accept the offer and another option 1920 to reject the offer.

In stage 1903, the user has accepted the offer to renew the subscription. In stage 1904, the user is forwarded to the publisher's web site (or server) as described above by reference to stage 1303 in FIG. 13A. After the subscription is renewed or an existing subscription is verified, the same channel as stage 1901 is displayed.

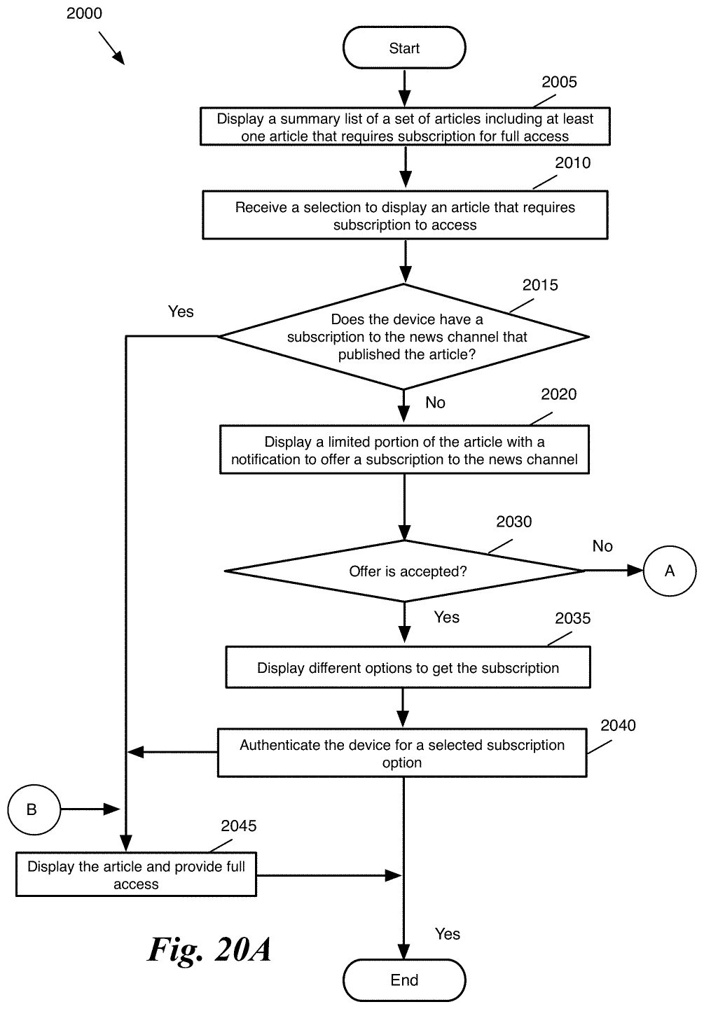

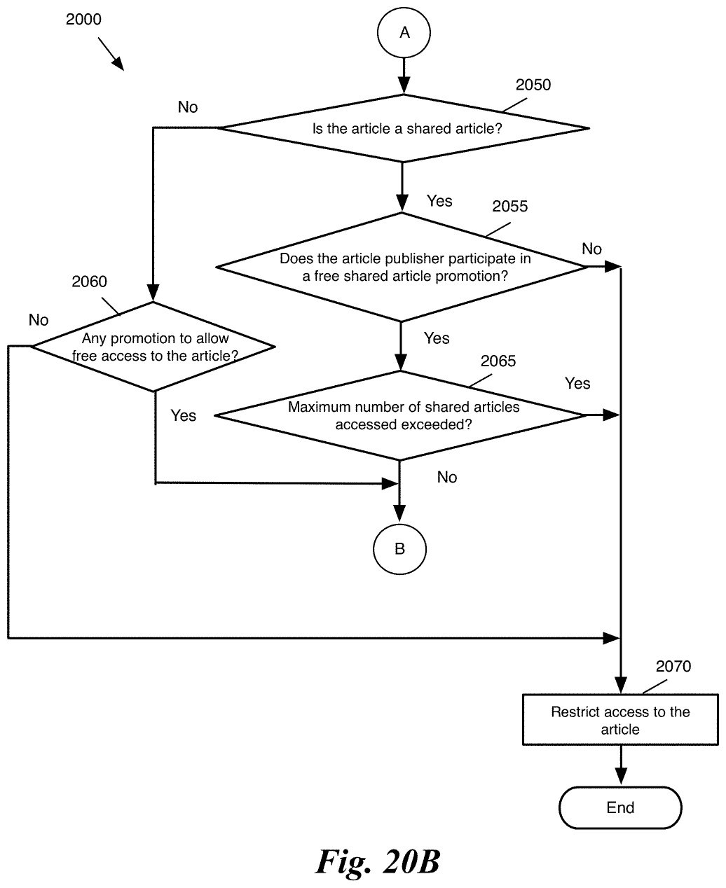

FIGS. 20A-20B conceptually illustrate a process 2000 for providing subscription to news channels in some embodiments. The process in some embodiments is performed by a device's news application. As shown, the process displays (at 2005) a summary list of a set of articles including at least one article that requires subscription for full access. For instance, the process displays a list of one or more articles as described above by reference to FIGS. 11A-19, above. For instance, the list of articles can be a list of articles provided in a favorite channel, one shared article, a list of articles displayed after a search or explore operation, etc.

The process then receives (at 2010) a selection to display an article in the list that requires subscription for access. The process then determines (at 2015) whether the device has a subscription to the news channel that published the article. If yes, the process displays (at 2045) the article and provides full access to the article as described above. The process then ends.

Otherwise, the process displays (at 2020) a limited portion of the article with a notification to offer a subscription to the news channel. The process then determines (at 2030) whether the offer is accepted (e.g., as described in stage 1103 in FIG. 11A). If not, the process proceeds to 2050, which is described below.

Otherwise, the process displays (at 2035) different options to get the subscription (e.g., as described in stage 1104 in FIG. 11A). The process then authenticates (at 2040) the device for a selected subscription option (e.g., as described in stages 1105-1108 in FIGS. 11A-11B). The process then proceeds to 2045, which was described above.

The process determines (at 2050) whether the article is a shared article. If not, the process proceeds to 2060, which is described below. Otherwise, the process determines (at 2055) whether the article publisher participates in a free shared-article promotion (e.g., as described above by reference to FIG. 16). If not, the process restricts (at 2070) access to the article. The process then ends.

Otherwise, the process determines (at 2065) whether the maximum number of shared articles accessed exceeded. If yes, the process proceeds to 2070, which was described above. Otherwise, the process proceeds to 2045, which was described above. The process determines (at 2060) whether there are any promotions to allow free access to the article. If not, the process proceeds to 2070, which was described above. Otherwise, the process proceeds to 2045, which was described above.

III. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

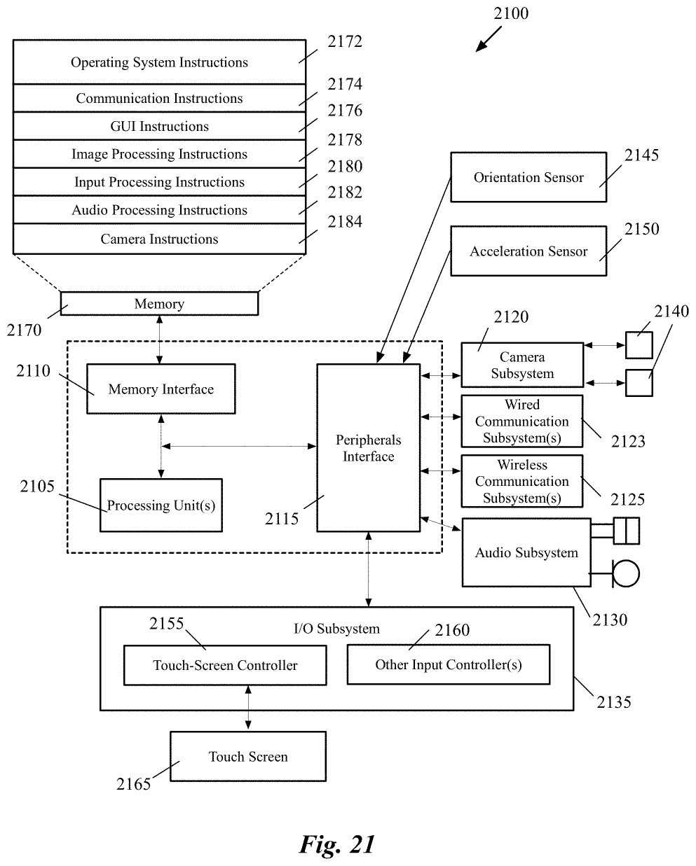

The applications of some embodiments operate on mobile devices, such as smart phones (e.g., iPhones®) and tablets (e.g., iPads®). FIG. 21 is an example of an architecture 2100 of such a mobile computing device. Examples of mobile computing devices include smartphones, tablets, laptops, etc. As shown, the mobile computing device 2100 includes one or more processing units 2105, a memory interface 2110 and a peripherals interface 2115.

The peripherals interface 2115 is coupled to various sensors and subsystems, including a camera subsystem 2120, a wired communication subsystem(s) 2123, a wireless communication subsystem(s) 2125, an audio subsystem 2130, an I/O subsystem 2135, etc. The peripherals interface 2115 enables communication between the processing units 2105 and various peripherals. For example, an orientation sensor 2145 (e.g., a gyroscope) and an acceleration sensor 2150 (e.g., an accelerometer) is coupled to the peripherals interface 2115 to facilitate orientation and acceleration functions.

The camera subsystem 2120 is coupled to one or more optical sensors 2140 (e.g., a charged coupled device (CCD) optical sensor, a complementary metal-oxide-semiconductor (CMOS) optical sensor, etc.). The camera subsystem 2120 coupled with the optical sensors 2140 facilitates camera functions, such as image and/or video data capturing. The wireless communication subsystem 2125 serves to facilitate communication functions. In some embodiments, the wireless communication subsystem 2125 includes radio frequency receivers and transmitters, and optical receivers and transmitters (not shown in FIG. 21). These receivers and transmitters of some embodiments are implemented to operate over one or more communication networks such as a GSM network, a Wi-Fi network, a Bluetooth network, etc. The audio subsystem 2130 is coupled to a speaker to output audio (e.g., to output voice navigation instructions). Additionally, the audio subsystem 2130 is coupled to a microphone to facilitate voice-enabled functions, such as voice recognition (e.g., for searching), digital recording, etc.

The I/O subsystem 2135 involves the transfer between input/output peripheral devices, such as a display, a touch screen, etc., and the data bus of the processing units 2105 through the peripherals interface 2115. The I/O subsystem 2135 includes a touch-screen controller 2155 and other input controllers 2160 to facilitate the transfer between input/output peripheral devices and the data bus of the processing units 2105. As shown, the touch-screen controller 2155 is coupled to a touch screen 2165. The touch-screen controller 2155 detects contact and movement on the touch screen 2165 using any of multiple touch sensitivity technologies. The other input controllers 2160 are coupled to other input/control devices, such as one or more buttons. Some embodiments include a near-touch sensitive screen and a corresponding controller that can detect near-touch interactions instead of or in addition to touch interactions.

The memory interface 2110 is coupled to memory 2170. In some embodiments, the memory 2170 includes volatile memory (e.g., high-speed random access memory), non-volatile memory (e.g., flash memory), a combination of volatile and non-volatile memory, and/or any other type of memory. As illustrated in FIG. 21, the memory 2170 stores an operating system (OS) 2172. The OS 2172 includes instructions for handling basic system services and for performing hardware dependent tasks.

The memory 2170 also includes communication instructions 2174 to facilitate communicating with one or more additional devices; graphical user interface instructions 2176 to facilitate graphic user interface processing; image processing instructions 2178 to facilitate image-related processing and functions; input processing instructions 2180 to facilitate input-related (e.g., touch input) processes and functions; audio processing instructions 2182 to facilitate audio-related processes and functions; and camera instructions 2184 to facilitate camera-related processes and functions. The instructions described above are merely exemplary and the memory 2170 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 21 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 21 may be split into two or more integrated circuits.

B. Computer System

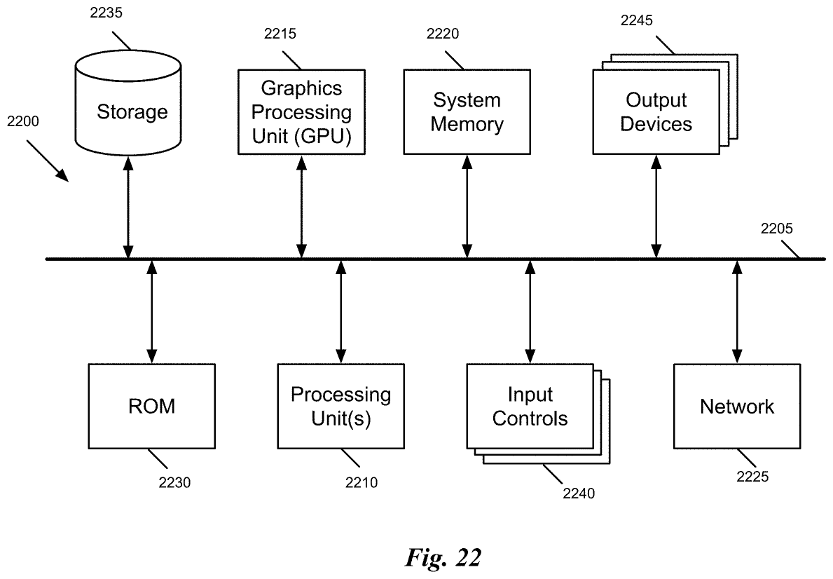

FIG. 22 conceptually illustrates another example of an electronic system 2200 with which some embodiments of the invention are implemented. The electronic system 2200 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2200 includes a bus 2205, processing unit(s) 2210, a graphics processing unit (GPU) 2215, a system memory 2220, a network 2225, a read-only memory 2230, a permanent storage device 2235, input devices 2240, and output devices 2245.

The bus 2205 collectively represents all system, peripheral, and chipset buses that communicatively connect the numerous internal devices of the electronic system 2200. For instance, the bus 2205 communicatively connects the processing unit(s) 2210 with the read-only memory 2230, the GPU 2215, the system memory 2220, and the permanent storage device 2235.

From these various memory units, the processing unit(s) 2210 retrieves instructions to execute and data to process in order to execute the processes of the invention. The processing unit(s) may be a single processor or a multi-core processor in different embodiments. Some instructions are passed to and executed by the GPU 2215. The GPU 2215 can offload various computations or complement the image processing provided by the processing unit(s) 2210.

The read-only-memory (ROM) 2230 stores static data and instructions that are needed by the processing unit(s) 2210 and other modules of the electronic system. The permanent storage device 2235, on the other hand, is a read-and-write memory device. This device is a non-volatile memory unit that stores instructions and data even when the electronic system 2200 is off. Some embodiments of the invention use a mass-storage device (such as a magnetic or optical disk and its corresponding disk drive, integrated flash memory) as the permanent storage device 2235.

Other embodiments use a removable storage device (such as a floppy disk, flash memory device, etc., and its corresponding drive) as the permanent storage device. Like the permanent storage device 2235, the system memory 2220 is a read-and-write memory device. However, unlike storage device 2235, the system memory 2220 is a volatile read-and-write memory, such a random access memory. The system memory 2220 stores some of the instructions and data that the processor needs at runtime. In some embodiments, the invention's processes are stored in the system memory 2220, the permanent storage device 2235, and/or the read-only memory 2230. For example, the various memory units include instructions for processing multimedia clips in accordance with some embodiments. From these various memory units, the processing unit(s) 2210 retrieves instructions to execute and data to process in order to execute the processes of some embodiments.

The bus 2205 also connects to the input and output devices 2240 and 2245. The input devices 2240 enable the user to communicate information and select commands to the electronic system. The input devices 2240 include alphanumeric keyboards and pointing devices (also called “cursor control devices”), cameras (e.g., webcams), microphones or similar devices for receiving voice commands, etc. The output devices 2245 display images generated by the electronic system or otherwise output data. The output devices 2245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 22 conceptually illustrates another example of an electronic system 2200 with which some embodiments of the invention are implemented. 22, bus 2205 also couples electronic system 2200 to a network 2225 through a network adapter (not shown). In this manner, the computer can be a part of a network of computers (such as a local area network (“LAN”), a wide area network (“WAN”), or an Intranet), or a network of networks, such as the Internet. Any or all components of electronic system 2200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

1-20. (canceled)

21. A tangible, non-transitory, computer-readable medium, comprising computer-readable instructions that, when executed by one or more processors of a computer, cause the computer to:
receive an indication of paid content at a non-subscriber electronic device;
provide limited access to the paid content by the non-subscriber electronic device, by:
determining a maximum number of free accesses to content;
determining whether accessing the paid content would breach the maximum number of free accesses to content;
providing access to the paid content by the non-subscriber electronic device when accessing the paid content would not breach the maximum number of free accesses to the content; and
refraining from providing access to the paid content by the non-subscriber electronic device when accessing the paid content would breach the maximum number of free accesses to the content.

22. The computer-readable medium of claim 21, wherein the maximum number of free accesses to content is provided by a publisher of the paid content.

23. The computer-readable medium of claim 22, wherein the publisher opts out of the limited access; and the computer-readable medium comprises computer-readable instructions that refrain from providing the limited access to the publisher's paid content based upon the publisher opting out of the limited access.

24. The computer-readable medium of claim 21, wherein the maximum number of free accesses to content is specific to a channel providing the paid content, where another channel is associated with a second maximum number of free accesses different than the maximum number of free accesses of the channel providing the paid content.

25. The computer-readable medium of claim 21, comprising computer-readable instructions that, when executed by the one or more processors of the computer, cause the computer to:
determine that the paid content has been shared to the non-subscriber device by a subscriber entitled to view the piece of content; and
provide the limited access to the paid content in response to determining the sharing by the subscriber.

26. The computer-readable medium of claim 25, wherein the sharing of the paid content to the non-subscriber device is limited to sharing by a subscriber of a channel providing the paid content.

27. The computer-readable medium of claim 21, comprising computer-readable instructions that, when executed by the one or more processors of the computer, cause the computer to:
provide, with the access to the paid content by the non-subscriber electronic device, a graphical placard providing a promotion of a subscription to a channel providing the paid content.

28. The computer-readable medium of claim 27, wherein the graphical placard comprises a selectable affordance for accepting the subscription.

29. The computer-readable medium of claim 21, comprising computer-readable instructions that, when executed by the one or more processors of the computer, cause the computer to:
provide, with the access to the paid content by the non-subscriber electronic device, one or more advertisements that are not provided with access to the paid content by a subscriber.

30. A computer-implemented method, comprising:
receiving an indication of paid content at a non-subscriber electronic device;
providing limited access to the paid content by the non-subscriber electronic device, by:
determining a maximum number of free accesses to content;
determining whether accessing the paid content would breach the maximum number of free accesses to content;
providing access to the paid content by the non-subscriber electronic device when accessing the paid content would not breach the maximum number of free accesses to the content; and
refraining from providing access to the paid content by the non-subscriber electronic device when accessing the paid content would breach the maximum number of free accesses to the content.

31. The computer-implemented method of claim 30, wherein the maximum number of free accesses to content is provided by a publisher of the paid content.

32. The computer-implemented method of claim 31, wherein the publisher opts out of the limited access; and the computer-implemented method comprises refraining from providing the limited access to the publisher's paid content based upon the publisher opting out of the limited access.

33. The computer-implemented method of claim 30, wherein the maximum number of free accesses to content is specific to a channel providing the paid content, where another channel is associated with a second maximum number of free accesses different than the maximum number of free accesses of the channel providing the paid content.

34. The computer-implemented method of claim 30, comprising:
determining that the paid content has been shared to the non-subscriber device by a subscriber entitled to view the piece of content; and
providing the limited access to the paid content in response to determining the sharing by the subscriber.

35. The computer-implemented method of claim 34, wherein the sharing of the paid content to the non-subscriber device is limited to sharing by a subscriber of a channel providing the paid content.

36. The computer-implemented method of claim 30, comprising:
providing, with the access to the paid content by the non-subscriber electronic device, a graphical placard providing a promotion of a subscription to a channel providing the paid content.

37. The computer-implemented method of claim 36, wherein the graphical placard comprises a selectable affordance for accepting the subscription.

38. The computer-implemented method of claim 30, comprising:
providing, with the access to the paid content by the non-subscriber electronic device, one or more advertisements that are not provided with access to the paid content by a subscriber.

39. A computer system, comprising:
one or more processors; and
memory, storing computer-readable instructions that, when executed by the one or more processors of the computer system, cause the computer system to:
receive an indication of paid content at a non-subscriber electronic device;
provide limited access to the paid content by the non-subscriber electronic device, by:
determining a maximum number of free accesses to content;
determining whether accessing the paid content would breach the maximum number of free accesses to content;
providing access to the paid content by the non-subscriber electronic device when accessing the paid content would not breach the maximum number of free accesses to the content; and
refraining from providing access to the paid content by the non-subscriber electronic device when accessing the paid content would breach the maximum number of free accesses to the content.

40. The computer system of claim 39, wherein the computer-readable instructions, when executed by the one or more processors of the computer, cause the computer system to
